(19) United States
(12) Patent Application Publication
(10) Pub. No.: US 2014/0325218 A1
(43) Pub. Date: Oct. 30, 2014

(54) Wireless Charging System Using Secure Wireless Charging Protocols

(71) Applicant: Toyota Jidosha Kabushiki Kaisha, Toyota-shi (JP)

(72) Inventors: Takayuki Shimizu, Mountain View, CA (US); Akihisa Yokoyama, Cupertino, CA (US); Atsushi Kawakubo, Toyota-shi (JP)

(73) Assignee: Toyota Jidosha Kabushiki Kaisha, Toyota-shi (JP)

(21) Appl. No.: 13/871,656

(22) Filed: Apr. 26, 2013

(51) Int. Cl. H04L 9/32

(52) U.S. Cl. CPC H04L 9/3271
USPC 713/168

(57) ABSTRACT

The disclosure includes a system and method for charging a target object wirelessly. The system includes a processor and a memory storing instructions that when executed cause the system to: receive data describing a charging request from a target object; generate a challenge responsive to the charging request; send the challenge to the target object; receive a response from the target object; verify the response to determine that the response matches the challenge and a first set of secret data shared with a tagging device; determine that a location associated with the target object satisfies a safe charging range responsive to the verification of the response; and instruct a power transmitter associated with the target object to transmit power wirelessly to a power receiver associated with the target object responsive to the verification of the response and the determination that the location satisfies the safe charging range.

### BACKGROUND

The specification relates to a wireless charging system.

A power receiver may receive power wirelessly from a power transmitter. However, the wireless charging implementation between the power receiver and the power transmitter may subject to various security threats including replay attack, eavesdropping, unauthorized charging and unauthorized access. For example, an attacker may impersonate the power receiver and obtain unauthorized charging from the power transmitter. In another example, an attacker may eavesdrop data that is exchanged between the power transmitter and the power receiver.

### SUMMARY

According to one innovative aspect of the subject matter described in this disclosure, a system for charging a target object wirelessly includes a processor and a memory storing instructions that, when executed, cause the system to: receive data describing a charging request from a target object; generate a challenge responsive to the charging request; send the challenge to the target object; receive a response from the target object; verify the response to determine that the response matches the challenge and a first set of secret data shared with a tagging device; determine that a location associated with the target object satisfies a safe charging range responsive to the verification of the response; and instruct a power transmitter associated with the target object to transmit power wirelessly to a power receiver associated with the target object responsive to the verification of the response and the determination that the location satisfies the safe charging range.

In general, another innovative aspect of the subject matter described in this disclosure may be embodied in methods that include: receiving data describing a charging request from a target object; generating a challenge responsive to the charging request; sending the challenge to the target object; receiving a response from the target object; verifying the response to determine that the response matches the challenge and a first set of secret data shared with a tagging device; determining that a location associated with the target object satisfies a safe charging range responsive to the verification of the response; and instructing a power transmitter associated with the target object to transmit power wirelessly to a power receiver associated with the target object responsive to the verification of the response and the determination that the location satisfies the safe charging range.

Other aspects include corresponding methods, systems, apparatus, and computer program products for these and other innovative aspects.

These and other implementations may each optionally include one or more of the following features. For instance, the features include: the response including a transformation of the challenge and the first set of secret data using a response function; the challenge being a random number uniquely associated with the charging request; the response received from the target object being encrypted using the session key; and performing, based on the second set of secret data, a challenge-response authentication process to authenticate the target object. For instance, the operations include: sharing a session key with the target object; receiving object authentication data from the target object; authenticating the target object based on the object authentication data and a second set of secret data shared with the target object; generating an authentication code associated with the challenge; and sending the authentication code to the tagging device via the target object.

The present disclosure may be particularly advantageous in a number of respects. For example, the system provides various secure wireless charging protocols that are capable of providing secure wireless charging to target objects. The system applies a challenge implementation, a data encryption implementation and one or more authentication processes to prevent one or more of replay attack, eavesdropping, unauthorized charging and unauthorized tag access.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for charging a target object wirelessly.

FIG. 2 is a block diagram illustrating an example of a control application.

FIG. 3 is a block diagram illustrating an example of an object application.

FIG. 4 is a block diagram illustrating an example of a tag application.

FIGS. 5A and 5B are flowcharts of an example method for charging a target object wirelessly on a charging controller side or on a charging server side.

FIGS. 6A and 6B are flowcharts of an example method for charging a target object wirelessly on a target object side.

FIG. 7 is a flowchart of an example method for charging a target object wirelessly on a tagging device side.

FIG. 8 is an event diagram illustrating an example process for implementing a wireless charging protocol.

FIG. 9 is an event diagram illustrating an example process for implementing a first secure wireless charging protocol.

FIG. 10 is an event diagram illustrating an example process for implementing a second secure wireless charging protocol.

FIG. 11 is an event diagram illustrating an example process for implementing a third secure wireless charging protocol.

FIG. 12 is an event diagram illustrating an example process for implementing a fourth secure wireless charging protocol.

FIG. 13 is an event diagram illustrating an example process for implementing a fifth secure wireless charging protocol.

FIG. 14 is an event diagram illustrating an example process for implementing a challenge-response authentication process.

FIG. 15 is a graphic representation illustrating various security features associated with various secure wireless charging protocols according to one embodiment.

FIG. 16 is a graphic representation illustrating an example wireless charging system.

FIG. 17 is a graphic representation illustrating an example safe charging range and an example safe charging distance.

### DETAILED DESCRIPTION

### Overview

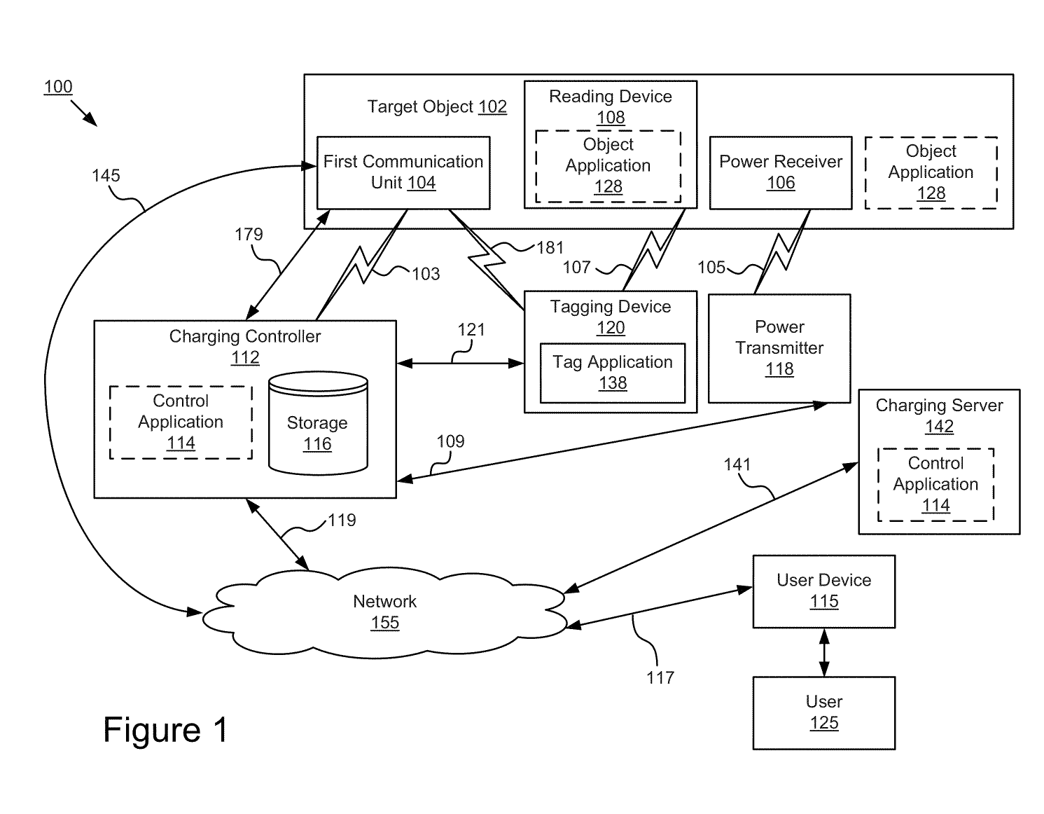

FIG. 1 illustrates a block diagram of some implementations of a system 100 for charging a target object 102 wirelessly. The illustrated system 100 includes a user device 115 that can be accessed by a user 125, a charging server 142, a charging controller 112, a target object 102, a power transmitter 118 and a tagging device 120. In some embodiments, the system 100 may include any other components associated with a charging system (e.g., a billing server).

In the illustrated implementation, the charging controller 112 is communicatively coupled to the power transmitter 118 via signal line 109. The charging controller 112 is communicatively coupled to the tagging device 120 via signal line 121. The charging controller 112 and the target object 102 communicate with each other via a wireless communication link 103 or signal line 179. In the illustrated implementation, the entities of the system 100 are communicatively coupled via a network 155. For example, the charging controller 112 is communicatively coupled to the network 155 via signal line 119. The charging server 142 is communicatively coupled to the network 155 via signal line 141. The user device 115 is communicatively coupled to the network 155 via signal line 117. The target object 102 is communicatively coupled to the network 155 via signal line 145. In one embodiment, each of signal lines 145, 179, 121, 109, 119, 141 and 117 represents a wired connection or a wireless connection.

The target object 102 can be any device that has a chargeable battery. Example target objects 102 include, but are not limited to, an electric vehicle, a hybrid electric vehicle, a robot with a chargeable battery, a mobile device with a chargeable battery and any other device configured to be chargeable with power. While FIG. 1 includes one target object 102, the system 100 may include one or more target objects 102. In the illustrated embodiment, the target object 102 includes a first communication unit 104, a power receiver 106, a reading device 108 and an object application 128. The object application 128 is depicted using dashed lines to indicate that while in one embodiment the object application 128 is included in the target object 102, in another embodiment the object application 128 can be included in the reading device 108. The target object 102 may include other components not shown in FIG. 1, for example, a chargeable battery, a display device for displaying remaining power capacity in the battery and an input device, etc.

The first communication unit 104 transmits and receives data to and from one or more of the charging controller 112, the charging server 142, the user device 115 and the tagging device 120. In some implementations, the first communication unit 104 includes a port for direct physical connection to the network 155 or to another communication channel. For example, the first communication unit 104 includes a USB, SD, CAT-5 or similar port for wired communication with the user device 115. In some implementations, the first communication unit 104 includes a wireless transceiver for exchanging data with the user device 115 or other communication channels using one or more wireless communication methods, including IEEE 802.11, IEEE 802.16, BLUETOOTH®, dedicated short-range communications (DSRC) or another suitable wireless communication method.

In one embodiment, the first communication unit 104 communicates with the charging controller 112 via a wireless communication link 103 using one or more wireless communication methods (e.g., IEEE 802.11, IEEE 802.16, BLUETOOTH®, DSRC, etc.). In one embodiment, the first communication unit 104 communicates with the tagging device 120 via a wireless communication link 181 using one or more wireless communication methods (e.g., IEEE 802.11, IEEE 802.16, BLUETOOTH®, DSRC, etc.).

In some implementations, the first communication unit 104 includes a cellular communications transceiver for sending and receiving data over a cellular communications network including via short messaging service (SMS), multimedia messaging service (MMS), hypertext transfer protocol (HTTP), direct data connection, WAP, e-mail or another suitable type of electronic communication. In some implementations, the first communication unit 104 includes a wired port and a wireless transceiver. The first communication unit 104 also provides other conventional connections to the network 155 for distribution of files and/or media objects using standard network protocols including TCP/IP, HTTP, HTTPS and SMTP, etc.

The power receiver 106 can be any device that receives power from a power source. For example, the power receiver 106 is a device that receives power wirelessly from the power transmitter 118 and stores the received power in a battery (not shown). In the illustrated embodiment, the power receiver 106 receives power from the power transmitter 118 via a wireless link 105. For example, the power transmitter 118 transmits power wirelessly to the power receiver 106.

The reading device 108 can be any device that reads data from other devices. For example, the reading device 108 is one of a radio frequency identification (RFID) reader and a near filed communication (NFC) reader. The reading device 108 reads data from the tagging device 120 via a wireless communication link 107.

The object application 128 can be code and routines for controlling the charging of a target object 102 on the target object side. In some implementations, the object application 128 can be implemented using hardware including a field-programmable gate array (FPGA) or an application-specific integrated circuit (ASIC). In some other implementations, the object application 128 can be implemented using a combination of hardware and software. In some implementations, the object application 128 may be stored in a combination of the devices and servers, or in one of the devices or servers.

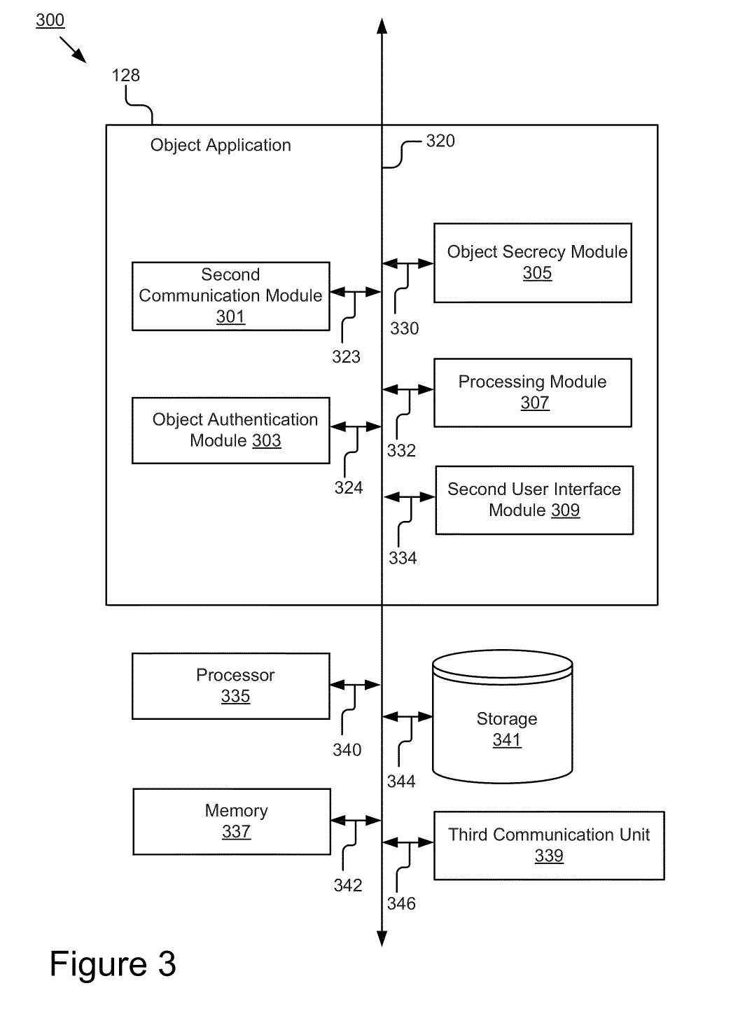

In one embodiment, the object application 128 determines that a power level of a battery associated with the target object 102 is below a predetermined threshold. The object application 128 generates a charging request for charging the target object 102. A charging request indicates a request to charge a target object 102. In another embodiment, the object application 128 automatically generates a charging request if the reading device 108 detects presence of the tagging device 120 located within a reading threshold, indicating the power transmitter 118 is located in close proximity to the power receiver 106. The reading threshold is described below in more detail. The object application 128 is described below in more detail with reference to FIGS. 3, 6A-6B and 8-13.

The power transmitter 118 can be any device that transmits power. For example, the power transmitter 118 is a device that transmits power to the power receiver 106 wirelessly. In one embodiment, if a charging distance between the power transmitter 118 and the power receiver 106 satisfies a safe charging distance (e.g., the charging distance≦the safe charging distance), which indicates that the power receiver 106 is in close proximity to the power transmitter 118, the power transmitter 118 is configured to wirelessly transmit power to the power receiver 106. However, if the charging distance does not satisfy the safe charging distance (e.g., the charging distance>the safe charging distance), the power transmitter 118 is not allowed to wirelessly transmit power to the power receiver 106.

A charging distance is a distance between the power transmitter 118 and the power receiver 106. A safe charging distance is a maximal charging distance within which the power transmitter 118 is capable of transmitting power safely to the power receiver 106 using a wireless connection. In some examples, the safe charging distance has a value between 0.1 millimeter and 50 meters. In some examples, the safe charging distance may have a value less than 0.1 millimeter. In other examples, the safe charging distance may have a value greater than 50 meters.

The tagging device 120 can be any device that provides data to be read by other devices. For example, the tagging device 120 provides data to be read by the reading device 108. For example, the tagging device 120 is one of a RFID tag and an NFC tag.

In one embodiment, the tagging device 120 stores secret data in a storage 441 associated with the tagging device 120. The secret data describes a secret key shared between the control application 114 and the tag application 138. The secret key is referred to as a controller-tag secret key. In another embodiment, the tagging device 120 stores a verification code in the storage 441. A verification code is data used to verify a location of a target object 102. For example, a verification code is secret data only shared between the control application 114 and the tagging device 120. For example, a verification code is a unique number, a unique symbol or a unique message, etc. Other example verification codes are possible. In one embodiment, the controller-tag secret key serves as a verification code and is used as the verification code for providing the functionality described herein. In another embodiment, the verification code is different from the controller-tag secret key.

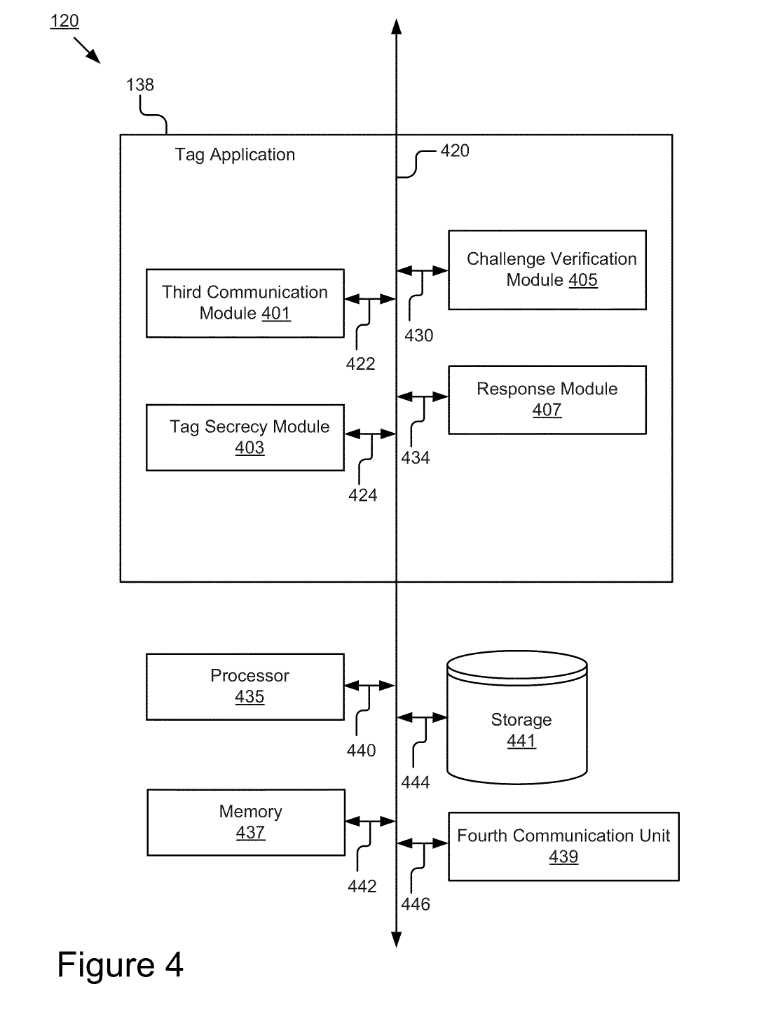

In the illustrated embodiment, the tagging device 120 includes a tag application 138. The tag application 138 can be code and routines for cooperating with the object application 128 and the control application 114 for charging a target object 102. In some implementations, the tag application 138 can be implemented using hardware including a field-programmable gate array (FPGA) or an application-specific integrated circuit (ASIC). In some other implementations, the tag application 138 can be implemented using a combination of hardware and software. In some implementations, the tag application 138 may be stored in a combination of the devices and servers, or in one of the devices or servers. The tag application 138 is described below in more detail with reference to FIGS. 4 and 7-13.

In one embodiment, the reading device 108 is configured to read data (e.g., a verification code, a response which is described below) from the tagging device 120 if a reading distance between the reading device 108 and the tagging device 120 satisfies a reading threshold (e.g., the reading distance≦the reading threshold). A reading distance is a distance between the reading device 108 and the tagging device 120. A reading threshold is a maximal reading distance within which the reading device 108 is capable of reading data correctly from the tagging device 120. For example, if the reading distance is less than or equal to the reading threshold, the reading device 108 is capable of reading the verification code correctly from the tagging device 120. However, if the reading distance is greater than the reading threshold, the reading device 108 fails to read the verification code from the tagging device 120. For example, if the reading distance is greater than the reading threshold, the reading device 108 may obtain an incorrect verification code from the tagging device 120 due to the reading error. In some embodiments, the reading device 108 cannot read any data from the tagging device 120 if the reading distance is greater than the reading threshold.

In one embodiment, the reading device 108 is a RFID reader and the tagging device 120 is a RFID tag. The RFID reader is capable of reading the verification code from the RFID tag successfully if the reading distance is less than or equal to a reading threshold. In another embodiment, the reading device 108 is a NFC reader and the tagging device 120 is a NFC tag. The NFC reader is capable of reading the verification code from the NFC tag successfully if the reading distance is less than or equal to a reading threshold.

In one embodiment, the reading threshold is configured by a user. In another embodiment, the reading threshold is configured by the reading device 108 and/or the tagging device 120. For example, the reading threshold is configured by the RFID reader and the RFID tag. In another example, the reading threshold is configured by the NFC reader and the NFC tag. In some examples, the reading threshold has a value between 0.1 millimeter and 50 meters. In some examples, the reading threshold may have a value less than 0.1 millimeter. In some examples, the reading threshold may have a value greater than 50 meters.

In one embodiment, the reading device 108 is configured to be positioned within a first distance from the power receiver 106, and the tagging device 120 is configured to be positioned within a second distance from the power transmitter 118. For example, the reading device 108 is placed adjacent to the power receiver 106, and the tagging device 120 is placed adjacent to the power transmitter 118. In another example, the reading device 120 is attached to or mounted on the power receiver 106, and the tagging device 120 is attached to or mounted on the power transmitter 118.

In some embodiments, (1) the placement of the reading device 108 in close proximity to the power receiver 106, (2) the placement of the tagging device 120 in close proximity to the power transmitter 118, (3) the value for the reading threshold and (4) the value for the safe charging distance can be configured in a way so that when the reading distance satisfies the reading threshold, the charging distance also satisfies the safe charging distance. In other words, when the reading device 108 can read data (e.g., a verification code, a response) successfully from the tagging device 120, which indicates (1) the reading device 108 is in close proximity to the tagging device 120 and (2) the power receiver 106 is in close proximity to the power transmitter 118, the power transmitter 118 can transmit power wirelessly to the power receiver 106.

For example, assume the reading device 108 is attached to the power receiver 106 and the tagging device 120 is attached to the power transmitter 118, so that the reading distance between the reading device 108 and the tagging device 120 is equal to the charging distance between the power receiver 106 and the power transmitter 118. Assume the safe charging distance is configured to be greater than the reading threshold. If the reading distance satisfies the reading threshold, the charging distance also satisfies the safe charging distance, which can be expressed in the following expressions:

because:

(1) the reading distance=the charging distance;

(2) the reading distance≦the reading threshold; and

(3) the reading threshold≦the safe charging distance;

thus:

the charging distance≦the safe charging distance.

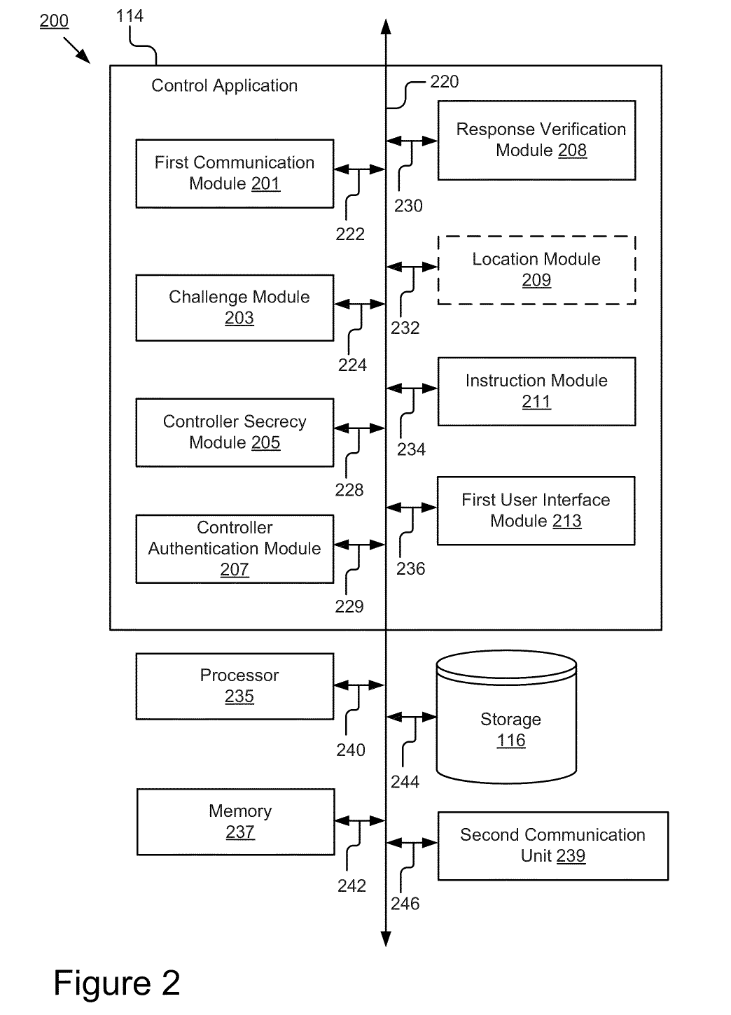

In one embodiment, the reading device 108 is configured to read a response from the tagging device 120. For example, the reading device 108 reads a response from the tagging device 120 responsive to a charging request. In another example, the reading device 108 is automatically activated to read the response from the tagging device 120 if the tagging device 120 is present within a distance satisfying the reading threshold. For example, the reading device 108 detects presence of the tagging device 120 located within the reading threshold and automatically reads the response from the tagging device 120 responsive to the presence of the tagging device 120. The reading device 108 sends the response to the control application 114 for verification. In some examples, a successful verification of the response indicates that: (1) the reading distance satisfies the reading threshold; and (2) the charging distance satisfies the safe charging distance. In this case, the power transmitter 118 can transmit power wirelessly to the power receiver 106. The verification of the response is described below in more detail with reference to FIG. 2.

A response is data generated by the tagging device 120 responsive to a request. In one embodiment, a response includes a verification code. In another embodiment, a response includes a transformation of a challenge and a controller-tag secret key. For example, a response is an output of a one-way function that uses the challenge and the controller-tag secret key as input data. Example one-way functions include, but are not limited to, a hash function, a message authentication code function, a universal one-way function and a universal hash function, etc.

A challenge is identification data identifying a charging process. For example, a challenge is a randomly generated number that is unique for each charging process. Different responses associated with different charging requests can be identified by different challenges.

The charging controller 112 can be any device that manages the charging of a target object 102. For example, the charging controller 112 is a computing device that includes a memory (not shown) and a processor (not shown). In some implementations the memory is a memory such as memory 237 described below with reference to FIG. 2. In some implementations the processor is a processor such as processor 235 described below with reference to FIG. 2. While FIG. 1 includes one charging controller 112, in practice one or more charging controllers 112 can be included in FIG. 1. In the illustrated embodiment, the charging controller 112 includes a control application 114 and a storage device 116. The control application 114 is depicted using dashed lines to indicate that while in one embodiment the control application 114 is included in the charging controller 112, in another embodiment the control application 114 is included in the charging server 142.

The control application 114 can be code and routines for controlling the charging of a target object 102. In some implementations, the control application 114 can be implemented using hardware including a field-programmable gate array (FPGA) or an application-specific integrated circuit (ASIC). In some other implementations, the control application 114 can be implemented using a combination of hardware and software. In some implementations, the control application 114 may be stored in a combination of the devices and servers, or in one of the devices or servers. The control application 114 is described below in more detail with reference to FIGS. 2, 5A-5B and 8-13.

The storage device 116 can be a non-transitory memory that stores data for providing the functionality described herein. The storage device 116 may be a dynamic random access memory (DRAM) device, a static random access memory (SRAM) device, flash memory or some other memory devices. In some implementations, the storage device 116 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. The storage device 116 is described below in more detail with reference to FIG. 2.

The charging server 142 can be a hardware server that includes a processor, a memory and network communication capabilities. The charging server 142 sends and receives data to and from other entities of the system 100 via the network 155. While FIG. 1 includes one charging server 142, the system 100 may include one or more charging servers 142. In one embodiment, the charging server 142 includes the control application 114.

The user device 115 can be a computing device that includes a memory and a processor, for example a laptop computer, a desktop computer, a tablet computer, a mobile telephone, a personal digital assistant (PDA), a mobile email device, a portable game player, a portable music player, a reader device, a television with one or more processors embedded therein or coupled thereto or other electronic device capable of accessing a network 155. In the illustrated implementation, the user 125 interacts with the user device 115. While FIG. 1 illustrates one user device 115, the present disclosure applies to a system architecture having one or more user devices 115.

The network 155 can be a conventional type, wired or wireless, and may have numerous different configurations including a star configuration, token ring configuration or other configurations. Furthermore, the network 155 may include a local area network (LAN), a wide area network (WAN) (e.g., the Internet), and/or other interconnected data paths across which multiple devices may communicate. In some implementations, the network 155 may be a peer-to-peer network. The network 155 may also be coupled to or includes portions of a telecommunications network for sending data in a variety of different communication protocols. In some implementations, the network 155 includes Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 155 coupled to the user device 115, the charging server 142, the target object 102 and the charging controller 112, in practice one or more networks 155 can be connected to these entities.

### Control Application 114

Referring now to FIG. 2, an example of the control application 114 is shown in more detail. FIG. 2 is a block diagram of a computing device 200 that includes a control application 114, a processor 235, a memory 237, a second communication unit 239 and a storage device 116 according to some examples. The components of the computing device 200 are communicatively coupled by a bus 220. In one embodiment, the computing device 200 is one of a charging controller 112 and a charging server 142.

The processor 235 includes an arithmetic logic unit, a microprocessor, a general purpose controller or some other processor array to perform computations and provide electronic display signals to a display device. The processor 235 is coupled to the bus 220 for communication with the other components via signal line 240. Processor 235 processes data signals and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included. Other processors, operating systems, sensors, displays and physical configurations are possible.

The memory 237 stores instructions and/or data that may be executed by the processor 235. The memory 237 is coupled to the bus 220 for communication with the other components via signal line 242. The instructions and/or data may include code for performing the techniques described herein. The memory 237 may be a dynamic random access memory (DRAM) device, a static random access memory (SRAM) device, flash memory or some other memory device. In some implementations, the memory 237 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The second communication unit 239 transmits and receives data to and from one or more of the charging controller 112, the target object 102, the charging server 142, the user device 115, the power transmitter 118 and the tagging device 120 depending upon where the control application 114 is stored. The second communication unit 239 is coupled to the bus 220 via signal line 246. In some embodiments, the second communication unit 239 has a similar structure and provides similar functionality as those described above for the first communication unit 104, and the description will not be repeated here.

In the illustrated implementation, the storage device 116 is communicatively coupled to the bus 220 via signal line 244. In some implementations, the storage device 116 stores one or more of: (1) secret data describing one or more of a controller-tag secret key, a controller-object secret key and a controller-object session key; (2) data describing a challenge; (3) data describing a safe charging range; (4) data describing a safe charging distance; and (5) data describing a verification code. The data stored in the storage device 116 is described below in more detail. In some implementations, the storage device 116 may store other data for providing the functionality described herein.

In the illustrated implementation shown in FIG. 2, the control application 114 includes a first communication module 201, a challenge module 203, a controller secrecy module 205, a controller authentication module 207, a response verification module 208, an optional location module 209, an instruction module 211 and a first user interface module 213. These components of the control application 114 are communicatively coupled to each other via the bus 220.

The first communication module 201 can be software including routines for handling communications between the control application 114 and other components of the computing device 200. In some implementations, the first communication module 201 can be a set of instructions executable by the processor 235 to provide the functionality described below for handling communications between the control application 114 and other components of the computing device 200. In some implementations, the first communication module 201 can be stored in the memory 237 of the computing device 200 and can be accessible and executable by the processor 235. The first communication module 201 may be adapted for cooperation and communication with the processor 235 and other components of the computing device 200 via signal line 222.

The first communication module 201 sends and receives data, via the second communication unit 239, to and from one or more of the user device 115, the target object 102, the charging server 142, the charging controller 112, the power transmitter 118 and the tagging device 120. For example, the first communication module 201 receives, via the second communication unit 239, data describing a response from the target object 102 and sends the data to the response verification module 208. In another example, the first communication module 201 receives graphical data for providing a user interface to a user from the first user interface module 213 and sends the graphical data to a user device 115, causing the user device 115 to present the user interface to the user.

In some implementations, the first communication module 201 receives data from other components of the control application 114 and stores the data in the storage device 116. For example, the first communication module 201 receives graphical data from the first user interface module 213 and stores the graphical data in the storage device 116. In some implementations, the first communication module 201 retrieves data from the storage device 116 and sends the retrieved data to other components of the control application 114. For example, the first communication module 201 retrieves data describing a controller-object secret key from the storage 116 and sends the data to the controller authentication module 207.

The challenge module 203 can be software including routines for generating a challenge. In some implementations, the challenge module 203 can be a set of instructions executable by the processor 235 to provide the functionality described below for generating a challenge. In some implementations, the challenge module 203 can be stored in the memory 237 of the computing device 200 and can be accessible and executable by the processor 235. The challenge module 203 may be adapted for cooperation and communication with the processor 235 and other components of the computing device 200 via signal line 224.

In one embodiment, the challenge module 203 receives a charging request from a target object 102 via the first communication module 201. The challenge module 203 generates a challenge responsive to the charging request. In one embodiment, a challenge is a random number uniquely identified a charging process associated with the charging request. For example, a challenge can be used by the tagging device 120 to generate a response that is uniquely identified by the challenge. Different responses are associated with different challenges. In some embodiments, the challenge module 213 generates different challenges for different charging processes. In one embodiment, a charging process is a process that the control application 114, the object application 128 and the tag application 138 cooperates with each other to charge the target object 102.

The uniqueness of a challenge associated with a particular charging process is beneficial because, for example, the unique challenge can be used to prevent replay attacks. In one embodiment, a replay attack is an attack that fraudulently or maliciously applies an invalid response (e.g., a previous response) to obtain charging authorization from the control application 114. For example, an attacker can obtain a copy of a previous response and send the copy of the previous response to the control application 114 in order to obtain charging approval from the control application 114. The control application 114 may fail to detect this replay attack if the previous response was not distinguishable from a current response. However, if each response for each charging process is uniquely associated with a unique challenge as described herein, the attackers cannot use any previous responses to obtain charging approval from the control application 114 because the previous responses do not match the current challenge.

In one embodiment, the challenge module 203 generates an authentication code for the challenge. An authentication code is data used to authenticate a challenge generated by the control application 114. For example, the authentication code is a message authentication code associated with the challenge. The message authentication code is, for example, output data from a message authentication code function which applies the challenge and the controller-tag secret key as input data. The challenge module 203 sends the challenge and the authentication code to the target object 102. The target object 102 relays the challenge and the authentication code to the tagging device 120, causing the tagging device 120 to verify the integrity and authenticity of the challenge and the authentication code using a copy of the controller-tag secret key stored in the tagging device 120. The verification of the challenge and the authentication code is described below with reference to FIG. 4.

The implementation of the authentication code is beneficial because, for example, the authentication code can prevent unauthorized tag access to the tagging device 120. For example, the tagging device 120 authenticates each challenge and each associated authentication code received from the target object 102 using the controller-tag secret key. The tagging device 120 generates a response for the challenge if the authentication of the challenge and the associated authentication code is successful. In this case, an attacker that has no knowledge of the controller-tag secret key cannot obtain access to the tagging device 120 using a fraudulent challenge, a fraudulent authentication code and/or a fraudulent controller-tag secret key.

In one embodiment, the challenge module 203 sends one or more of the challenge and the associated authentication code to the target object 102. In another embodiment, the challenge module 203 stores one or more of the challenge and the associated authentication code in the storage device 116.

The controller secrecy module 205 can be software including routines for managing secret data associated with the control application 114. In some implementations, the controller secrecy module 205 can be a set of instructions executable by the processor 235 to provide the functionality described below for managing secret data associated with the control application 114. In some implementations, the controller secrecy module 205 can be stored in the memory 237 of the computing device 200 and can be accessible and executable by the processor 235. The controller secrecy module 205 may be adapted for cooperation and communication with the processor 235 and other components of the computing device 200 via signal line 228.

In one embodiment, the controller secrecy module 205 manages secret data describing one or more of a controller-tag secret key and a controller-object secret key. A controller-tag secret key is a secret key shared between the control application 114 and the tag application 138. A controller-object secret key is a secret key shared between the control application 114 and the target object 102. For example, the controller secrecy module 205 generates a controller-tag secret key and distributes the controller-tag secret key to the tagging device 120 via a secure channel. In another example, the controller secrecy module 205 generates a controller-object secret key and distributes the controller-object secret key to the target object 102 via a secure channel. A secure channel is a channel through which data can be transmitted securely. For example, a secure channel is a channel through which the exchanged data is encrypted using cryptographic keys including secret keys or a pair of a public key and a private key.

In another embodiment, the controller secrecy module 205 cooperates with an object secrecy module 305 of the target object 102 to share a controller-object session key with the target object 102. For example, the controller secrecy module 205 generates a controller-object session key and distributes the controller-object session key to the target object 102 via a secure channel. A controller-object session key is a secret key used in a communication session between the control application 114 and the target object 102. In one embodiment, the controller-object session key is used to encrypt and decrypt data exchanged in a communication session between the control application 114 and the objection application 128. The control application 114 and the target object 102 may use different controller-object session keys for different communication sessions.

The controller authentication module 207 can be software including routines for authenticating a target object 102. In some implementations, the controller authentication module 207 can be a set of instructions executable by the processor 235 to provide the functionality described below for authenticating a target object 102. In some implementations, the controller authentication module 207 can be stored in the memory 237 of the computing device 200 and can be accessible and executable by the processor 235. The controller authentication module 207 may be adapted for cooperation and communication with the processor 235 and other components of the computing device 200 via signal line 229.

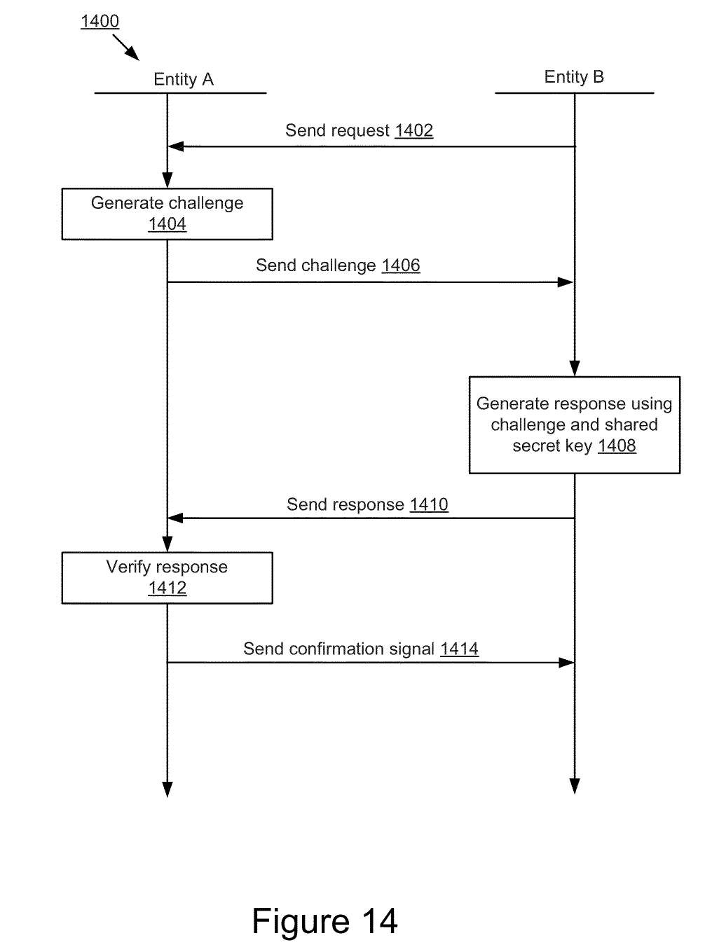

In one embodiment, the controller authentication module 207 cooperates with an object authentication module 303 of the object application 128 to authenticate the target object 102. For example, the controller authentication module 207 cooperates with the object authentication module 303 to perform a challenge-response authentication process using the controller-object secret key. An example challenge-response authentication process is illustrated with reference to FIG. 14. For example, the object authentication module 303 generates a response including object authentication data, and sends the response to the controller authentication module 207. The controller authentication module 207 verifies the response by confirming that: (1) the object authentication data included in the response is associated with the current challenge; and (2) the object authentication data is generated by the target object 102 using the controller-object secret key and the challenge. The controller authentication module 207 authenticates the target object 102 by verifying the response.

Object authentication data is data generated by the target object 102 and used by the control application 114 to authenticate the target object 102. For example, the object authentication data describes a message authentication code associated with the challenge and the controller-object secret key. In another example, the object authentication data is data outputted from a one-way function that uses the challenge and the controller-object secret key as input data. The controller authentication module 207 authenticates the object authentication data using a copy of the challenge and a copy of the controller-object secret key stored in the storage 116.

The authentication of the target object 102 is beneficial because, for example, the authentication prevents unauthorized charging incurred by attackers that impersonate the target object 102. For example, because the attackers do not have knowledge of the controller-object secret key, it is impossible for the attackers to generate object authentication data that matches both the controller-object secret key and the challenge. The attackers therefore fail in the authentication process performed by the controller authentication module 207 and cannot be charged without authorization.

The response verification module 208 can be software including routines for verifying a response. In some implementations, the response verification module 208 can be a set of instructions executable by the processor 235 to provide the functionality described below for verifying a response. In some implementations, the response verification module 208 can be stored in the memory 237 of the computing device 200 and can be accessible and executable by the processor 235. The response verification module 208 may be adapted for cooperation and communication with the processor 235 and other components of the computing device 200 via signal line 230.

In one embodiment, a response is generated by the tagging device 120 responsive to a charging request from the target object 102. The generation of the response is described below with reference to FIG. 4. In one embodiment, a response includes a verification code used to verify whether a location of the target object 102 satisfies a safe charging range. A safe charging range is described below in more detail. In another embodiment, a response includes output data from a response function using the controller-tag secret key and the challenge as input data. For example, a response (represented as the symbol “R”) is expressed as:

R=f(C,S_{controller-tag}),

where the symbol “f” represents a response function, the symbol “C” represents the challenge, the symbol “S_{controller-tag}” represents the controller-tag secret key, “C” and “S_{controller-tag}” are inputs to the response function “f.” In one embodiment, a response function is a one-way function such as a cryptographic hash function, a message authentication code function or a universal one-way function, etc. Other example response functions are possible.

In one embodiment, a response is encrypted using a controller-object session key.

An example encrypted response (represented by the symbol “R_{encrypt}”) is expressed as:

R_{encrypt}=g(R=f(C,S_{controller-tag}),K_{controller-object-session}),

where the symbol “g” represents a cryptographic encryption function (e.g., an advanced encryption standard, a triple data encryption algorithm, etc.), the symbol “K_{controller-object-session}” represents a controller-object session key, “R=f(C,S_{controller-tag})” and “K_{controller-object-session}” are inputs to the encryption function “g.”

In one embodiment, the reading device 108 included in the target object 102 reads a response from the tagging device 120. For example, the target object 102 generates a charging request to charge a battery of the target object 102. The reading device 108 sends the charging request to the tagging device 120. The tagging device 120 generates a response and sends the response to the reading device 108. The reading device 108 is capable of reading the response successfully from the tagging device 120 if the reading distance between the reading device 108 and the tagging device 120 satisfies a reading threshold (e.g., the reading distance≦the reading threshold). The reading device 108 fails to read the response from the tagging device 120 if the reading distance does not satisfy the reading threshold (e.g., the reading distance>the reading threshold). For example, the reading device 108 may obtain an incorrect response from the tagging device 120 due to the reading error. The reading device 108 sends the response to the object application 128 which delivers the response to the response verification module 208. In one embodiment, the object application 128 processes the response before sending the response to the response verification module 208. The processing of the response by the object application 128 is described below with reference to FIG. 3.

In one embodiment, the response verification module 208 receives a response from the object application 128 and verifies the received response. For example, the response verification module 208 determines whether the received response matches the challenge and the controller-tag secret key. For example, assume the received response (represented by “R_{received}”) is expressed as: R_{received}=f(C, S_{controller-tag}). The response verification module 208 retrieves a copy of the challenge and a copy of the controller-tag secret key stored in the storage device 116, and computes a response as “R_{computed}=f (C_{copy}, S_{controller-tag, copy}),” where “C_{copy}” represents the copy of the challenge and “S_{controller-tag, copy}” represents the copy of the controller-tag secret key. If the computed response matches the received response (e.g., R_{received}=R_{computed}), the response verification module 208 determines that the verification of the received response is successful. Otherwise, the response verification module 208 determines that the verification of the received response fails.

In another embodiment, the received response is an encrypted response. The response verification module 208 decrypts the received response using a corresponding session key. For example, assume the received response is expressed as:

R_{encrypt}=g(R=f(C,S_{controller-tag}),K_{controller-object-session}).

The response verification module 208 decrypts the received response using the controller-object session key to obtain a decrypted response “R_{decrypted}=f (C, S_{controller-tag}).” The response verification module 208 determines whether the decrypted response matches the challenge and the controller-tag secret key by: (1) computing a response “R_{computed}=f (C_{copy}, S_{controller-tag, copy});” and (2) comparing the decrypted response “R_{decrypted}=f (C, S_{controller-tag})” to “R_{computed}=f (C_{copy}, S_{controller-tag, copy}).” If the decrypted response matches the computed response, the response verification module 208 determines that the verification of the response is successful. Otherwise, the response verification module 208 determines that the verification of the response fails.

In one embodiment, a successful verification of the response indicates: (1) the reading device 108 is in close proximity to the tagging device 120, and the power transmitter 118 is in close proximity to the power receiver 106; (2) the reading device 108 is capable of reading the response successfully from the tagging device 120; (3) the reading distance between the reading device 108 and the tagging device 120 satisfies a reading threshold; and (4) the charging distance between the power transmitter 118 and the power receiver 106 of the target object 102 satisfies the safe charging distance.

If the verification of the response is successful, the response verification module 208 sends a verification confirmation signal to one or more of the location module 209, the instruction module 211 and the target object 102.

The location module 209 can be software including routines for determining a location associated with the target object 102. In some implementations, the location module 209 can be a set of instructions executable by the processor 235 to provide the functionality described below for determining a location associated with the target object 102. In some implementations, the location module 209 can be stored in the memory 237 of the computing device 200 and can be accessible and executable by the processor 235. The location module 209 may be adapted for cooperation and communication with the processor 235 and other components of the computing device 200 via signal line 232.

In one embodiment, the location module 209 receives a verification confirmation signal from the response verification module 208, indicating the verification of the response is successful. Responsive to the verification confirmation signal, the location module 209 determines that the location of the target object 102 satisfies a safe charging range. For example, the location module 209 determines that the location of the target object 102 is within a safe charging range. The location module 209 sends a location-verification signal to the instruction module 211, indicating the location of the target object 102 is verified to be within the safe charging range.

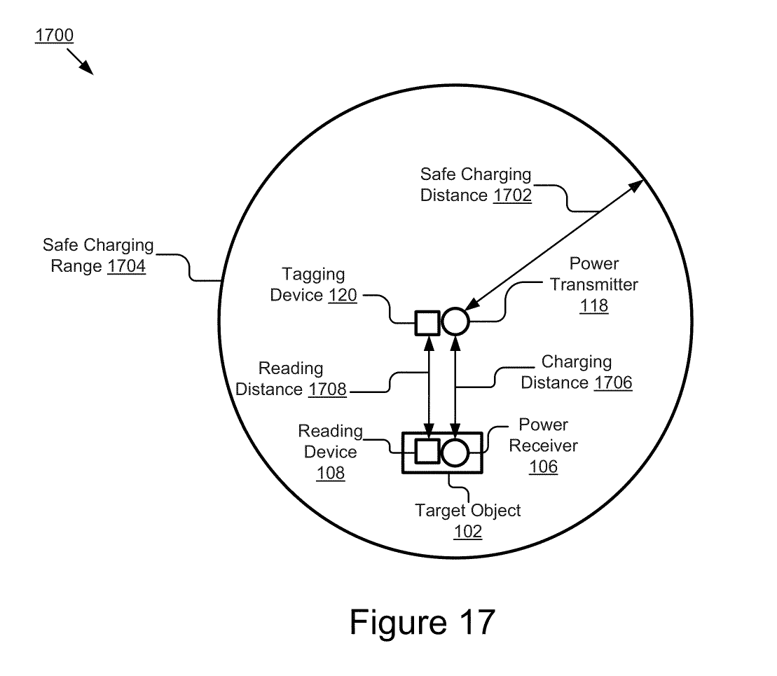

A safe charging range is a maximal charging range within which a target object 102 is configured to be charged wirelessly by the power transmitter 118. For example, if the location of the target object 102 is within the safe charging range, the target object 102 can be charged wirelessly by the power transmitter 118. However, if the target object 102 is outside the safe charging range, the target object 102 cannot be charged wirelessly by the power transmitter 118. In one embodiment, the safe charging range is determined based on the safe charging distance. An example safe charging range is illustrated in FIG. 17.

The instruction module 211 can be software including routines for instructing the power transmitter 118 to charge the target object 102. In some implementations, the instruction module 211 can be a set of instructions executable by the processor 235 to provide the functionality described below for instructing the power transmitter 118 to charge the target object 102. In some implementations, the instruction module 211 can be stored in the memory 237 of the computing device 200 and can be accessible and executable by the processor 235. The instruction module 211 may be adapted for cooperation and communication with the processor 235 and other components of the computing device 200 via signal line 234.

In one embodiment, the instruction module 211 receives a verification confirmation signal from the response verification module 208, and approves the charging of the target object 102 responsive to the verification confirmation signal. For example, the instruction module 211 instructs the power transmitter 118 to start transmitting power to the power receiver 106 wirelessly. In another embodiment, the instruction module 211 also receives a location-verification signal from the location module 209, indicating the location associated with the target object 102 satisfies a safe charging range. The instruction module 211 approves the charging of the target object 102 by instructing the power transmitter 118 to start transmitting power to the power receiver 106 wirelessly. In yet another embodiment, the instruction module 211 instructs the first user interface module 213 to generate graphical data for providing a user interface that depicts a charging progress (e.g., 50% full of battery, 1-hour remaining charging time, etc.) to the user.

The first user interface module 213 can be software including routines for generating graphical data for providing user interfaces to users. In some implementations, the first user interface module 213 can be a set of instructions executable by the processor 235 to provide the functionality described below for generating graphical data for providing user interfaces to users. In some implementations, the first user interface module 213 can be stored in the memory 237 of the computing device 200 and can be accessible and executable by the processor 235. The first user interface module 213 may be adapted for cooperation and communication with the processor 235 and other components of the computing device 200 via signal line 236.

In some implementations, the first user interface module 213 generates graphical data for providing a user interface that presents a charging progress to the user. The first user interface module 213 sends the graphical data to a user device 115, causing the user device 115 to present the user interface to the user. The first user interface module 213 may generate graphical data for providing other user interfaces to users.

### Object Application 128

Referring now to FIG. 3, an example of the object application 128 is shown in more detail. FIG. 3 is a block diagram of a computing device 300 that includes an object application 128, a processor 335, a memory 337, a third communication unit 339 and a storage device 341 according to some examples. The components of the computing device 300 are communicatively coupled by a bus 320. In one embodiment, the computing device 300 is one of the target object 102 and a reading device 108 included in the target object 102.

In the illustrated embodiment, the processor 335 is communicatively coupled to the bus 320 via signal line 340. The processor 335 has similar structure and provides similar functionality as those described above for the processor 235, and the description will not be repeated here. The memory 337 is communicatively coupled to the bus 320 via signal line 342. The memory 337 has similar structure and provides similar functionality as those described above for the memory 237, and the description will not be repeated here. The third communication unit 339 is communicatively coupled to the bus 320 via signal line 346. The third communication unit 339 has similar structure and provides similar functionality as those described above for the first communication unit 104, and the description will not be repeated here.

In the illustrated embodiment, the storage 341 is communicatively coupled to the bus 320 via signal line 344. The storage 341 has similar structure and provides similar functionality as those described above for the storage 116, and the description will not be repeated here. In one embodiment, the storage 341 stores one or more of: (1) secret data describing a controller-object secret key, a controller-object session key and an object-tag session key; (2) a challenge; and (3) a response received from the tagging device 120. The storage 341 may store other data for providing the functionality described herein.

An object-tag session key is a secret key used in a communication session between the target object 102 and the tagging device 120. In one embodiment, the object-tag session key is used by the objection application 128 and the tag application 138 to encrypt and decrypt data exchanged in a communication session between the target object 102 and the tagging device 120. The object application 128 and the tag application 138 may use different object-tag session keys for different communication sessions between the target object 102 and the tagging device 120.

In the illustrated embodiment, the object application 128 includes a second communication module 301, an object authentication module 303, an object secrecy module 305, a processing module 307 and a second user interface module 309. The components of the object application 128 are communicatively coupled via the bus 320.

The second communication module 301 can be software including routines for handling communications between the object application 128 and other components of the computing device 300. In some implementations, the second communication module 301 can be a set of instructions executable by the processor 335 to provide the functionality described below for handling communications between the object application 128 and other components of the computing device 300. In some implementations, the second communication module 301 can be stored in the memory 337 of the computing device 300 and can be accessible and executable by the processor 335. The second communication module 301 may be adapted for cooperation and communication with the processor 335 and other components of the computing device 300 via signal line 323.

The second communication module 301 sends and receives data, via the third communication unit 339, to and from one or more of the user device 115, the charging controller 112, the charging server 142, the power transmitter 118 and the tagging device 120. For example, the second communication module 301 receives data describing a response from the tagging device 120 and sends the data to the processing module 307. In another example, the second communication module 301 receives graphical data for providing a user interface to a user from the second user interface module 309 and sends the graphical data to a user device 115, causing the user device 115 to present the user interface to the user.

In some implementations, the second communication module 301 receives data from other components of the object application 128 and stores the data in the storage device 341. In some implementations, the second communication module 301 retrieves data from the storage device 341 and sends the retrieved data to other components of the object application 128.

The object authentication module 303 can be software including routines for cooperating with the controller authentication module 207 to authenticate the target object 102. In some implementations, the object authentication module 303 can be a set of instructions executable by the processor 335 to provide the functionality described below for cooperating with the controller authentication module 207 to authenticate the target object 102. In some implementations, the object authentication module 303 can be stored in the memory 337 of the computing device 300 and can be accessible and executable by the processor 335. The object authentication module 303 may be adapted for cooperation and communication with the processor 335 and other components of the computing device 300 via signal line 324.

In one embodiment, the object authentication module 303 cooperates with the controller authentication module 207 to authenticate the target object 102. For example, the object authentication module 303 cooperates with the controller authentication module 207 to perform a challenge-response authentication process using the controller-object secret key. For example, the object authentication module 303 generates a response including object authentication data. The object authentication module 303 sends the response to the controller authentication module 207, causing the controller authentication module 207 to verify the response including the object authentication data by performing operations similar to those described above with reference to FIG. 2.

The object secrecy module 305 can be software including routines for managing secret data associated with the target object 102. In some implementations, the object secrecy module 305 can be a set of instructions executable by the processor 335 to provide the functionality described below for managing secret data associated with the target object 102. In some implementations, the object secrecy module 305 can be stored in the memory 337 of the computing device 300 and can be accessible and executable by the processor 335. The object secrecy module 305 may be adapted for cooperation and communication with the processor 335 and other components of the computing device 300 via signal line 330.

In one embodiment, the object secrecy module 305 manages secret data describing a controller-object secret key. For example, the object secrecy module 305 receives a controller-object secret key from the controller secrecy module 205 via a secure channel and stores the controller-object secret key in the storage 341. In another embodiment, the object secrecy module 305 cooperates with the controller secrecy module 205 to share a controller-object session key. For example, the object secrecy module 305 receives a controller-object session key from the controller secrecy module 205 via a secure channel and stores the controller-object session key in the storage 341.

In one embodiment, the object secrecy module 305 cooperates with a tag secrecy module 403 of the tagging device 120 to share an object-tag session key with the tag application 138. For example, the object secrecy module 305 generates an object-tag session key and distributes the object-tag session key to the tag application 138 via a secure channel. An object-tag session key is a secret key used in a communication session between the target object 102 and the tagging device 120. In one embodiment, the object-tag session key is used to encrypt and decrypt data exchanged in a communication session between the objection application 128 and the tag application 138. The tag application 138 and the object application 128 may use different object-tag session keys for different communication sessions between the objection application 128 and the tag application 138.

The processing module 307 can be software including routines for processing a challenge received from the control application 114 and/or a response received from the tag application 138. In some implementations, the processing module 307 can be a set of instructions executable by the processor 335 to provide the functionality described below for processing a challenge received from the control application 114 and/or a response received from the tag application 138. In some implementations, the processing module 307 can be stored in the memory 337 of the computing device 300 and can be accessible and executable by the processor 335. The processing module 307 may be adapted for cooperation and communication with the processor 335 and other components of the computing device 300 via signal line 332.

In one embodiment, the processing module 307 receives, via the second communication module 301, one or more of a challenge and an authentication code associated with the challenge from the control application 114, and forwards the one or more of the challenge and the authentication code to the tag application 138. In one embodiment, the processing module 307 also stores the challenge and the authentication code in the storage 341.

In one embodiment, the processing module 307 receives, via the second communication module 301, a response from the tag application 138 and forwards the response to the control application 114. For example, the processing module 307 receives a response “R=f (C, S_{controller-tag})” from the tag application 138 and sends the response to the control application 114. In another embodiment, the processing module 307 encrypts the response “R=f (C, S_{controller-tag})” using a controller-object session key to generate an encrypted response:

R_{encrypt}=g(R=f(C,S_{controller-tag}),K_{controller-object-session}).

The processing module 307 sends the encrypted response to the control application 114.

In one embodiment, the processing module 307 receives a first encrypted response from the tag application 138 which is represented as:

R_{encrypt-tag}=g(R=f(C,S_{controller-tag}),K_{object-tag-session}),

where the symbol “K_{object-tag-session}” represents an object-tag session key, “R=f (C, S_{controller-tag})” and “K_{object-tag-session}” are inputs to the encryption function “g.” The processing module 307 decrypts the first encrypted response using the object-tag session key and obtains a decrypted response “R=f (C, S_{controller-tag}).” Next, the processing module 307 encrypts the decrypted response “R=f (C, S_{controller-tag})” using a controller-object session key, and generates a second encrypted response:

R_{encrypt}=g(R=f(C,S_{controller-tag}),K_{controller-object-session}).

The processing module 307 sends the second encrypted response to the control application 114.

The encryption of the response is beneficial because, for example, the implementation of encryption prevents attackers to eavesdrop the response exchanged between the control application 114, the object application 128 and the tag application 138.

The second user interface module 309 can be software including routines for generating graphical data for providing user interfaces to users. In some implementations, the second user interface module 309 can be a set of instructions executable by the processor 335 to provide the functionality described below for generating graphical data for providing user interfaces to users. In some implementations, the second user interface module 309 can be stored in the memory 337 of the computing device 300 and can be accessible and executable by the processor 335. The second user interface module 309 may be adapted for cooperation and communication with the processor 335 and other components of the computing device 300 via signal line 334.

In some implementations, the second user interface module 309 generates graphical data for providing a user interface to the user. The second user interface module 309 sends the graphical data to a user device 115, causing the user device 115 to present the user interface to the user. For example, the user interface informs the user that the power capacity in the target object 102 is below a predetermined threshold and requests the user's consent for charging the target object 102. The second user interface module 309 may generate graphical data for providing other user interfaces to users.

### Tag Application 138

Referring now to FIG. 4, an example of the tag application 138 is shown in more detail. FIG. 4 is a block diagram of a tagging device 120 that includes a tag application 138, a processor 435, a memory 437, a fourth communication unit 439 and a storage device 441 according to some examples. The components of the tagging device 120 are communicatively coupled by a bus 420.

In the illustrated embodiment, the processor 435 is communicatively coupled to the bus 420 via signal line 440. The processor 435 has similar structure and provides similar functionality as those described above for the processor 235, and the description will not be repeated here. The memory 437 is communicatively coupled to the bus 420 via signal line 442. The memory 437 has similar structure and provides similar functionality as those described above for the memory 237, and the description will not be repeated here. The fourth communication unit 439 is communicatively coupled to the bus 420 via signal line 446. The fourth communication unit 439 has similar structure and provides similar functionality as those described above for the first communication unit 104, and the description will not be repeated here.

In the illustrated embodiment, the storage 441 is communicatively coupled to the bus 420 via signal line 444. The storage 441 has similar structure and provides similar functionality as those described above for the storage 116, and the description will not be repeated here. In one embodiment, the storage 441 stores a verification code and secret data describing a controller-tag secret key and an object-tag session key. The storage 441 may store other data for providing the functionality described herein.

In the illustrated embodiment, the tag application 138 includes a third communication module 401, a tag secrecy module 403, a challenge verification module 405 and a response module 407. The components of the tag application 138 are communicatively coupled via the bus 420.

The third communication module 401 can be software including routines for handling communications between the tag application 138 and other components of the tagging device 120. In some implementations, the third communication module 401 can be a set of instructions executable by the processor 435 to provide the functionality described below for handling communications between the tag application 138 and other components of the tagging device 120. In some implementations, the third communication module 401 can be stored in the memory 437 of the tagging device 120 and can be accessible and executable by the processor 435. The third communication module 401 may be adapted for cooperation and communication with the processor 435 and other components of the tagging device 120 via signal line 422.

The third communication module 401 sends and receives data, via the fourth communication unit 439, to and from one or more of the user device 115, the charging controller 112, the charging server 142 and the target object 102. For example, the third communication module 401 receives, via the fourth communication unit 439, data describing a challenge from the object application 128 and sends the data to the challenge verification module 405. In another example, the third communication module 401 receives a response from the response module 407 and sends the response to the object application 128.

In some implementations, the third communication module 401 receives data from other components of the tag application 138 and stores the data in the storage device 441. In some implementations, the third communication module 401 retrieves data from the storage device 441 and sends the retrieved data to other components of the tag application 138.

The tag secrecy module 403 can be software including routines for managing secret data associated with the tag application 138. In some implementations, the tag secrecy module 403 can be a set of instructions executable by the processor 435 to provide the functionality described below for managing secret data associated with the tag application 138. In some implementations, the tag secrecy module 403 can be stored in the memory 437 of the tagging device 120 and can be accessible and executable by the processor 435. The tag secrecy module 403 may be adapted for cooperation and communication with the processor 435 and other components of the tagging device 120 via signal line 424.

In one embodiment, the tag secrecy module 403 manages secret data describing a controller-tag secret key. For example, the tag secrecy module 403 receives a controller-tag secret key from the controller secrecy module 205 via a secure channel and stores the controller-tag secret key in the storage 441. In another embodiment, the tag secrecy module 403 cooperates with the object secrecy module 305 to share an object-tag session key with the object application 128. For example, the tag secrecy module 403 receives an object-tag session key from the object secrecy module 305 via a secure channel and stores the object-tag session key in the storage device 441.

The challenge verification module 405 can be software including routines for verifying a challenge. In some implementations, the challenge verification module 405 can be a set of instructions executable by the processor 435 to provide the functionality described below for verifying a challenge. In some implementations, the challenge verification module 405 can be stored in the memory 437 of the tagging device 120 and can be accessible and executable by the processor 435. The challenge verification module 405 may be adapted for cooperation and communication with the processor 435 and other components of the tagging device 120 via signal line 430.

In one embodiment, the challenge verification module 405 receives a challenge and an associated authentication code from the object application 128. The challenge verification module 405 determines the authenticity of the challenge and the associated authentication code using a controller-tag secret key. For example, assume the associated authentication code is a message authentication code. The challenge verification module 405 retrieves a copy of the controller-tag secret key from the storage 441 and computes a message authentication code using the received challenge and the copy of the controller-tag secret key. If the computed message authentication code matches the received message authentication code (e.g., the computed message authentication code=the received message authentication code), the challenge verification module 405 determines that the verification of the challenge and the associated authentication code is successful. The challenge verification module 405 instructs the response module 407 to generate a response using the received challenge. If the computed message authentication code does not match the received message authentication code, the challenge verification module 405 determines that the verification of the challenge and the associated authentication code fails.

The response module 407 can be software including routines for generating a response. In some implementations, the response module 407 can be a set of instructions executable by the processor 435 to provide the functionality described below for generating a response. In some implementations, the response module 407 can be stored in the memory 437 of the tagging device 120 and can be accessible and executable by the processor 435. The response module 407 may be adapted for cooperation and communication with the processor 435 and other components of the tagging device 120 via signal line 434.

In one embodiment, the response module 407 generates a response responsive to a charging request received from the object application 128. In another embodiment, the response module 407 generates a response responsive to a successful verification of the challenge and the associated authentication code. For example, the response module 407 generates a response “R=f (C, S_{controller-tag})” using the received challenge and the controller-tag secret key. The response module 407 sends the response “R=f (C, S_{controller-tag})” to the object application 128. In another example, the response module 407 encrypts the response “R=f (C, S_{controller-tag})” using the object-tag session key to generate an encrypted response:

R_{encrypt-tag}=g(R=f(C,S_{controller-tag}),K_{object-tag-session}).

The response module 407 sends the encrypted response to the object application 128. The response module 407 may generate other example responses using the challenge and the controller-tag secret key.

### Methods

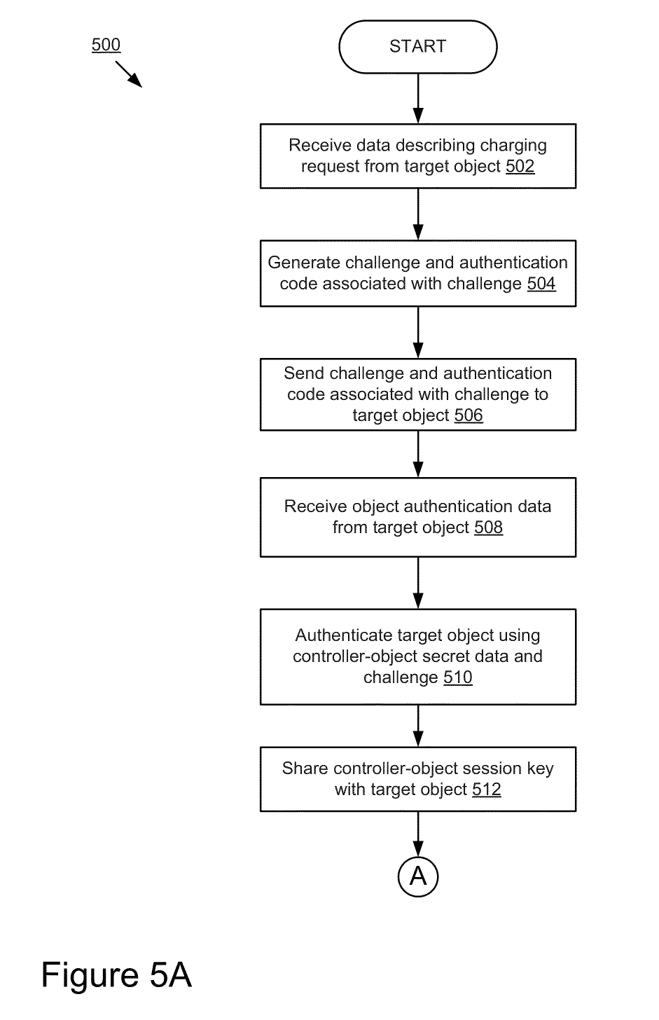

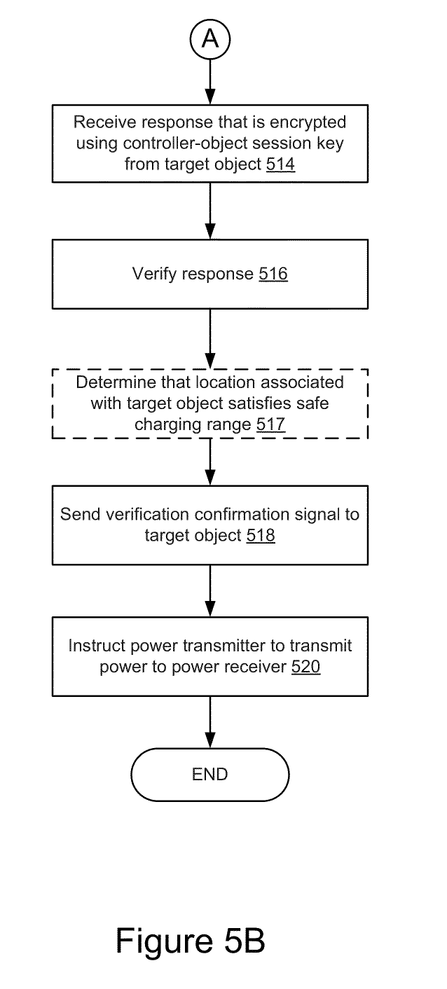

FIGS. 5A and 5B are flowcharts of an example method 500 for charging a target object 102 wirelessly on a charging controller side or on a charging server side. Referring to FIG. 5A, in one embodiment the first communication module 201 receives 502 data describing a charging request from the target object 102. The challenge module 203 generates 504 a challenge and an authentication code associated with the challenge. The first communication module 201 sends 506 the challenge and the authentication code to the target object 102. The first communication module 201 receives 508 object authentication data from the target object 102. The controller authentication module 207 authenticates 510 the target object 102 using a controller-object secret key, the challenge and the object authentication data. The controller secrecy module 205 shares 512 a controller-object session key with the target object 102.

Referring to FIG. 5B, the first communication module 201 receives 514 a response that is encrypted using the controller-object session key from the target object 102. The response verification module 208 verifies 516 the response. The location module 209 optionally determines 517 that a location associated with the target object 102 satisfies a safe charging range responsive to a successful verification of the response. The first communication module 201 sends 518 a verification confirmation signal to the target object 102. The instruction module 211 instructs 520 the power transmitter 118 to transmit power to the power receiver 106 responsive to the successful verification of the response.

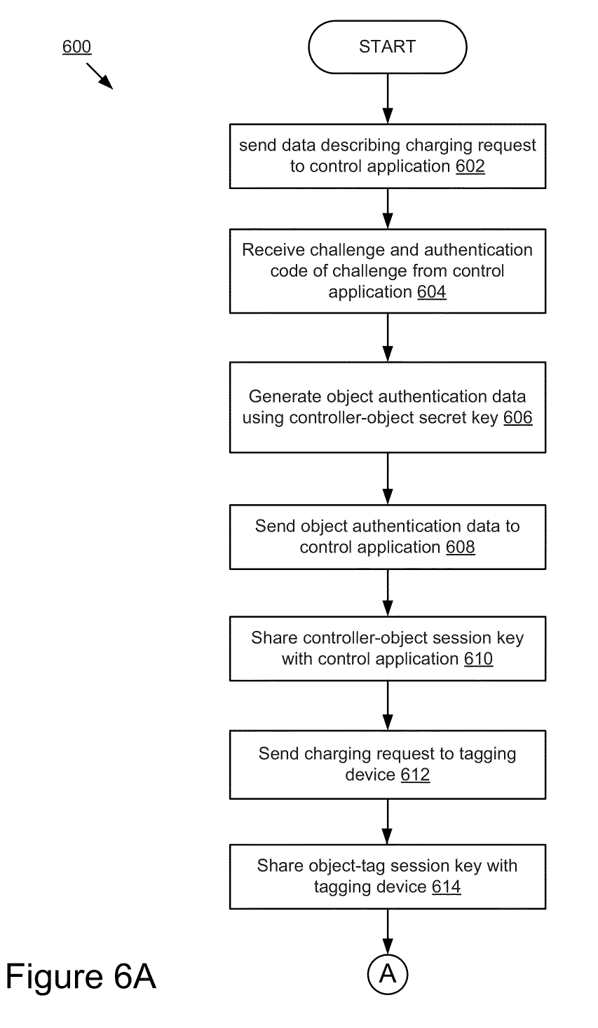

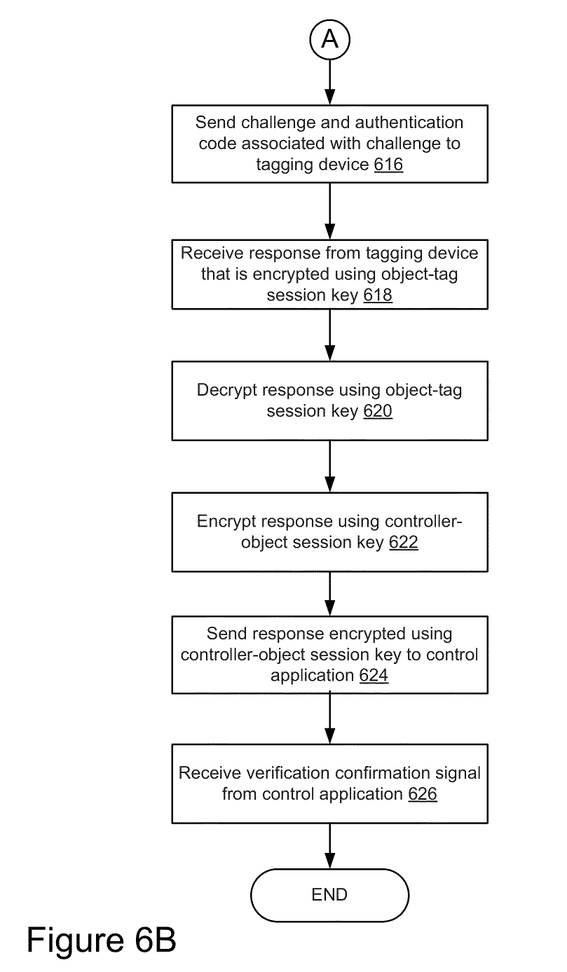

FIGS. 6A and 6B are flowcharts of an example method 600 for charging a target object 102 wirelessly on a target object side. Referring to FIG. 6A, in one embodiment the second communication module 301 generates a charging request and sends 602 data describing the charging request to the control application 114. The second communication module 301 receives 604 a challenge and an authentication code associated with the challenge from the control application 114. The object authentication module 303 generates 606 object authentication data using a controller-object secret key and the challenge. The second communication module 301 sends 608 the object authentication data to the control application 114. The object secrecy module 305 shares 610 a controller-object session key with the control application 114. The second communication module 301 sends 612 the charging request to the tagging device 120. The object secrecy module 305 shares 614 an object-tag session key with the tagging device 120.

Referring to FIG. 6B, the second communication module 301 sends 616 the challenge and the authentication code to the tagging device 120. The second communication module 301 receives 618 a response from the tagging device 120 that is encrypted using the object-tag session key. The processing module 307 decrypts 620 the response using the object-tag session key. The processing module 307 encrypts 622 the decrypted response using a controller-object session key. The second communication module 301 sends 624 the response encrypted using the controller-object session key to the control application 114. The second communication module 301 receives 626 a verification confirmation signal from the control application 114 if the control application 114 successfully verifies the response.

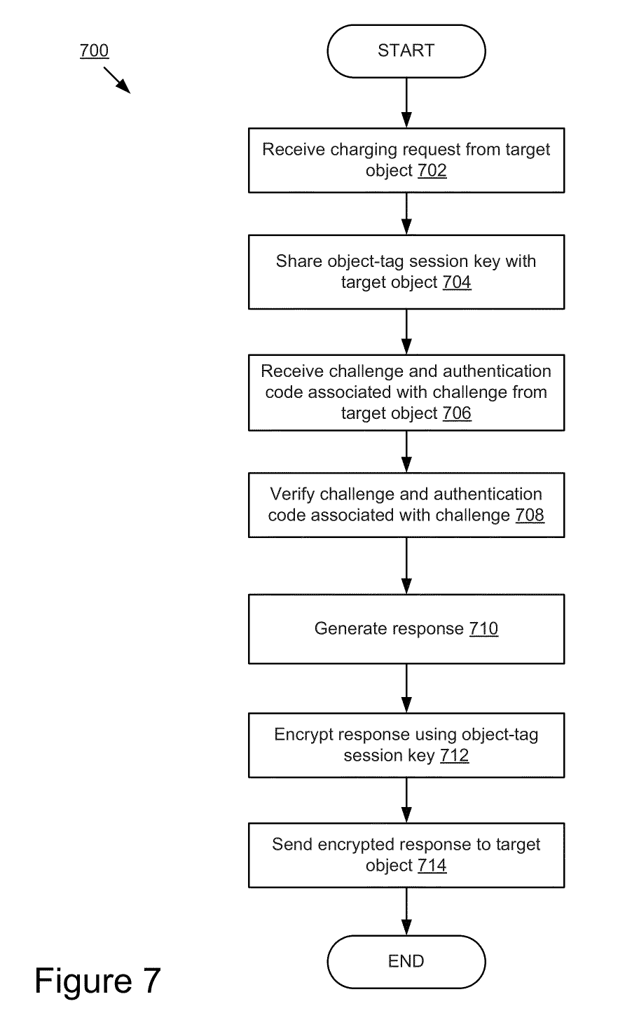

FIG. 7 is a flowchart of an example method 700 for charging a target object 102 wirelessly on a tagging device side. In one embodiment, the third communication module 401 receives 702 a charging request from the target object 102. The tag secrecy module 403 shares 704 an object-tag session key with the target object 102. The third communication module 401 receives 706 a challenge and an authentication code associated with the challenge from the target object 102. The challenge verification module 405 verifies 708 the challenge and the authentication code associated with the challenge. The response module 407 generates 710 a response responsive to a successful verification of the challenge and the authentication code. The response module 407 encrypts 712 the response using an object-tag session key. The third communication module 401 sends 714 the encrypted response to the target object 102.

### Event Diagrams

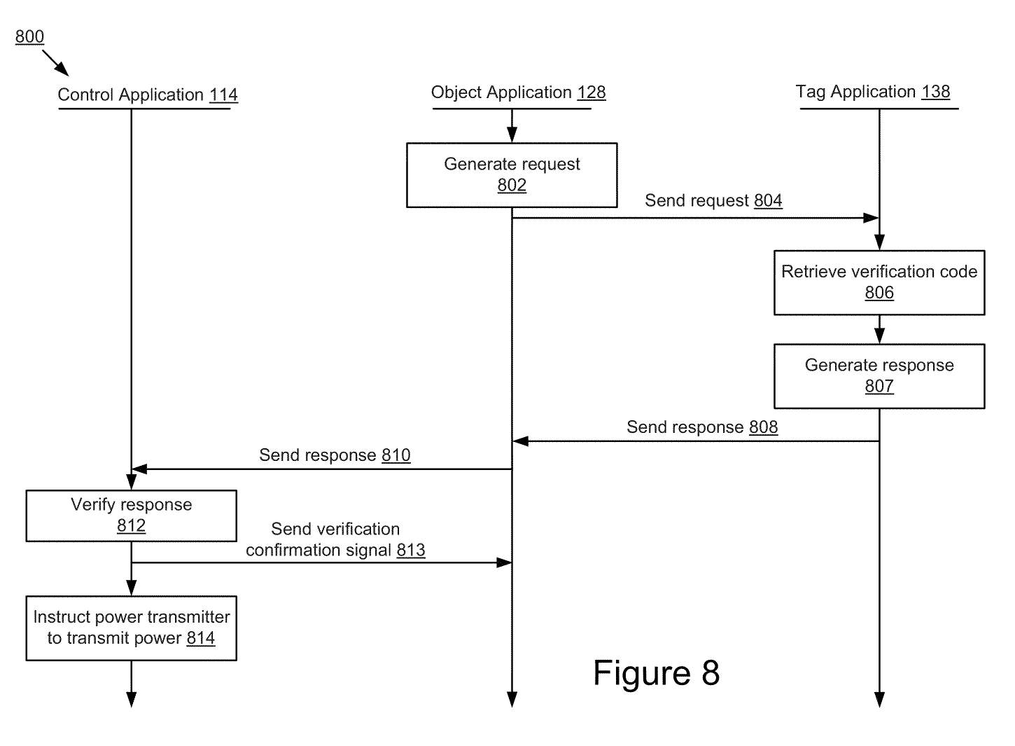

FIG. 8 is an event diagram illustrating an example process 800 for implementing an example wireless charging protocol. In one embodiment, the object application 128 generates 802 a charging request and sends 804 the charging request to the tag application 138. The tag application 138 retrieves 806 a verification code from the storage 441. The tag application 138 generates 807 a response based on the verification code and sends 808 the response to the object application 128. The object application 128 sends 810 the response to the control application 114. The control application 114 verifies 812 the response. The control application 114 sends 813 a verification confirmation signal to the object application 128 responsive to a successful verification of the response. The control application 114 instructs 814 the power transmitter 118 to transmit power to the power receiver 106 responsive to the successful verification of the response.

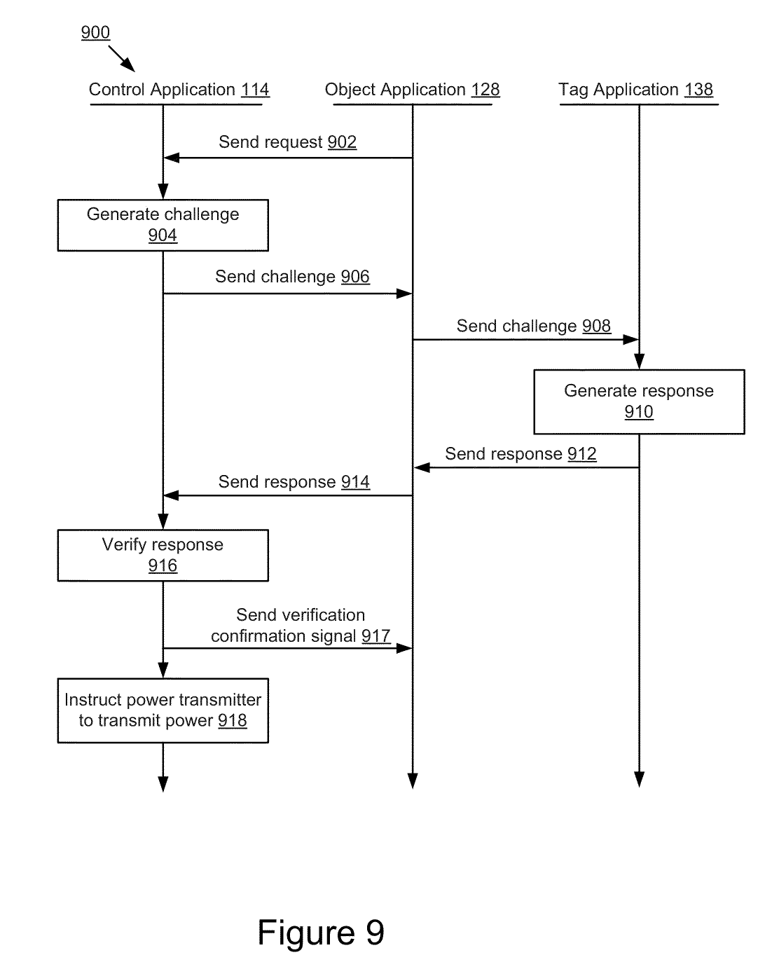

FIG. 9 is an event diagram illustrating an example process 900 for implementing a first secure wireless charging protocol. In one embodiment, the control application 114 and the tag application 138 share a controller-tag secret key. The object application 128 sends 902 a charging request to the control application 114. The control application 114 generates 904 a challenge and sends 906 the challenge to the object application 128. The object application 128 sends 908 the challenge to the tag application 138. The tag application 138 generates 910 a response “R=f (C, S_{controller-tag})” using the challenge (represented as “C”) and the controller-tag secret key (represented as “S_{controller-tag}”). The tag application 138 sends 912 the response to the object application 128. The object application 128 sends 914 the response to the control application 114. The control application 114 verifies 916 the response. The control application 114 sends 917 a verification confirmation signal to the object application 128 responsive to a successful verification of the response. The control application 114 instructs 918 the power transmitter 118 to transmit power to the power receiver 106 responsive to the successful verification of the response.

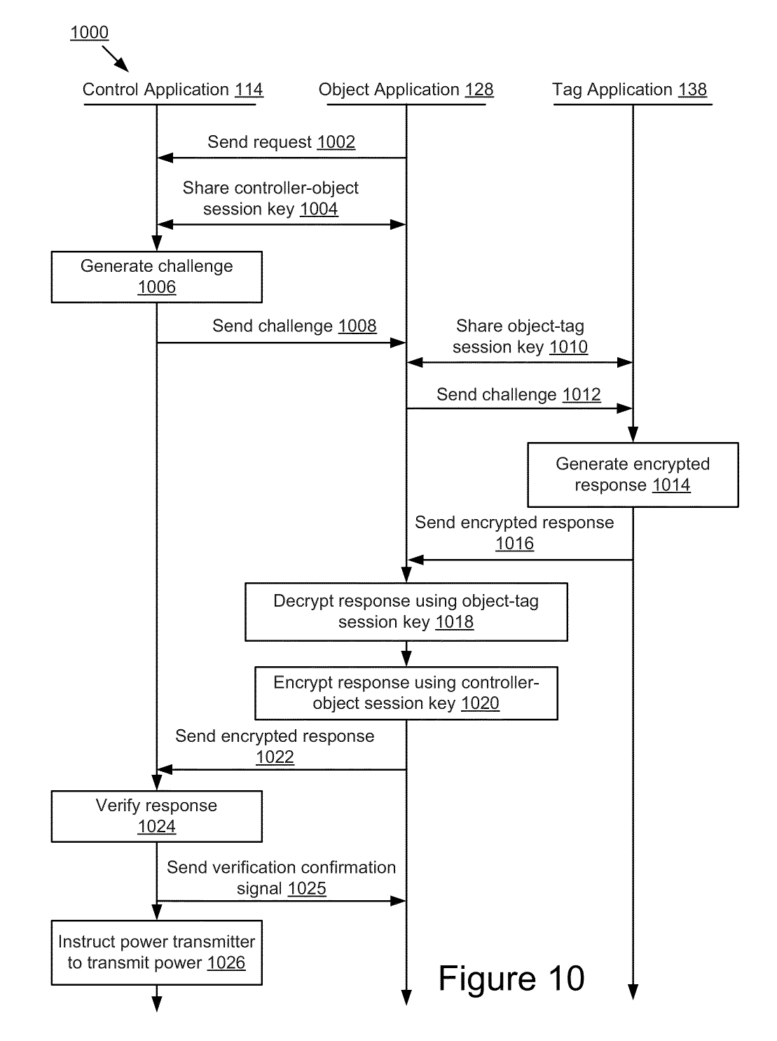

FIG. 10 is an event diagram illustrating an example process 1000 for implementing a second secure wireless charging protocol. In one embodiment, the control application 114 and the tag application 138 share a controller-tag secret key. In one embodiment, the object application 128 sends 1002 a charging request to the control application 114. The object application 128 and the control application 114 share 1004 a controller-object session key with each other. The control application 114 generates 1006 a challenge and sends 1008 the challenge to the object application 128. The object application 128 and the tag application 138 share 1010 an object-tag session key. The object application 128 sends 1012 the challenge to the tag application 138. The tag application 138 generates 1014 a first encrypted response:

R_{encrypt-tag}=g=f(C,S_{controller-tag}),K_{object-tag-session}),

using the controller-tag secret key (represented as “S_{controller-tag}”), the challenge (represented as “C”) and the object-tag session key (represented as “K_{object-tag-session}”). The tag application 138 sends 1016 the first encrypted response to the object application 128.

The object application 128 decrypts 1018 the first encrypted response using the object-tag session key. The object application 128 encrypts 1020 the response using a controller-object session key (represented as “K_{controller-object-session}”) and generates a second encrypted response:

R_{encrypt}=g(R=f(C,S_{controller-tag}),K_{controller-object-session}).

The object application 128 sends 1022 the second encrypted response to the control application 114. The control application 114 verifies 1024 the second encrypted response. The control application 114 sends 1025 a verification confirmation signal to the object application 128 responsive to a successful verification of the response. The control application 114 instructs 1026 the power transmitter 118 to transmit power to the power receiver 106 responsive to the successful verification of the response.

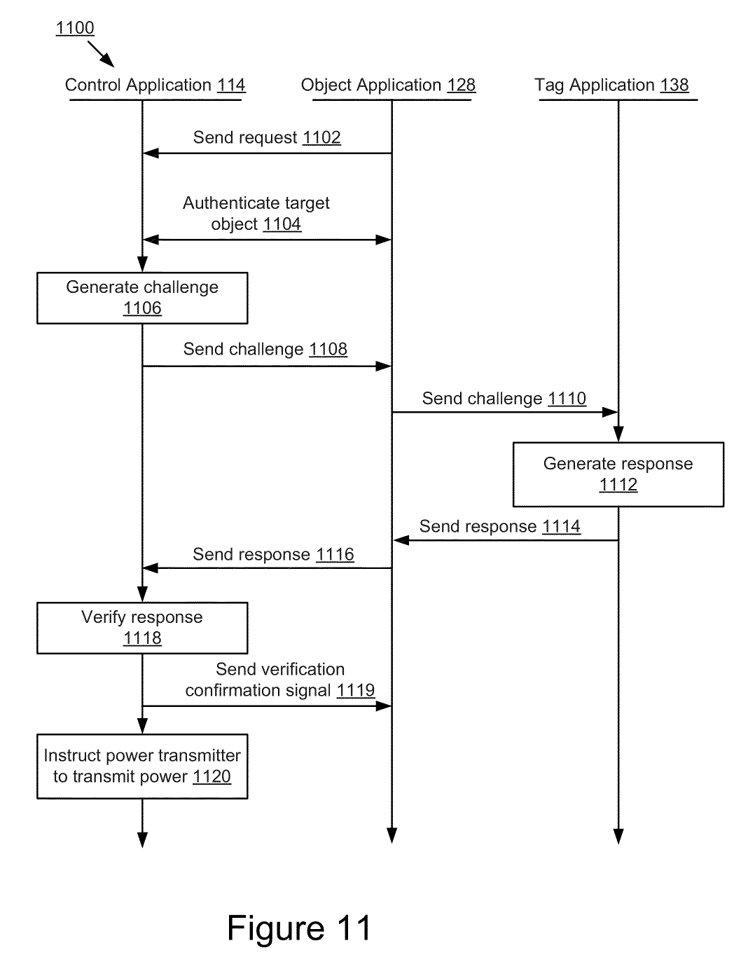

FIG. 11 is an event diagram illustrating an example process 1100 for implementing a third secure wireless charging protocol. In one embodiment, the control application 114 shares a controller-tag secret key with the tag application 138 and a controller-object secret key with the object application 128. The object application 128 sends 1102 a charging request to the control application 114. The control application 114 cooperates with the object application 128 to authenticate 1104 the target object 102. The control application 114 generates 1106 a challenge and sends 1108 the challenge to the object application 128.

The object application 128 sends 1110 the challenge to the tag application 138. The tag application 138 generates 1112 a response “R=f(C, S_{controller-tag}).” The tag application 138 sends 1114 the response to the object application 128. The object application 128 sends 1116 the response to the control application 114. The control application 114 verifies 1118 the response. The control application 114 sends 1119 a verification confirmation signal to the object application 128 responsive to a successful verification of the response. The control application 114 instructs 1120 the power transmitter 118 to transmit power to the power receiver 106 associated with the target object 102.

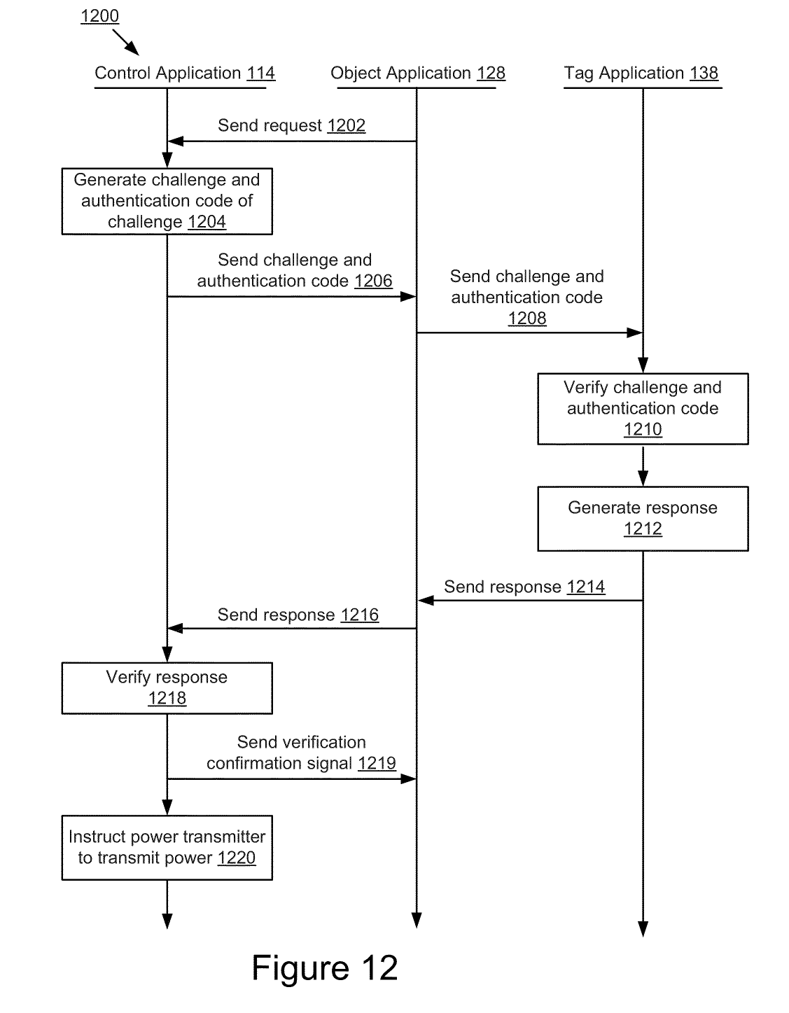

FIG. 12 is an event diagram illustrating an example process 1200 for implementing a fourth secure wireless charging protocol. In one embodiment, the control application 114 and the tag application 138 share a controller-tag secret key. The object application 128 sends 1202 a charging request to the control application 114. The control application 114 generates 1204 a challenge and an authentication code associated with the challenge. The control application 114 sends 1206 the challenge and the authentication code to the object application 128. The object application 128 sends 1208 the challenge and the authentication code to the tag application 138.

The tag application 138 verifies 1210 the challenge and the authentication code. The tag application 138 generates 1212 a response “R=f (C, S_{controner-tag})” responsive to a successful verification of the challenge and the authentication code. The tag application 138 sends 1214 the response to the object application 128. The object application 128 sends 1216 the response to the control application 114. The control application 114 verifies 1218 the response. The control application 114 sends 1219 a verification confirmation signal to the object application 128 responsive to a successful verification of the response. The control application 114 instructs 1220 the power transmitter 118 to transmit power to the power receiver 106 responsive to the successful verification of the response.

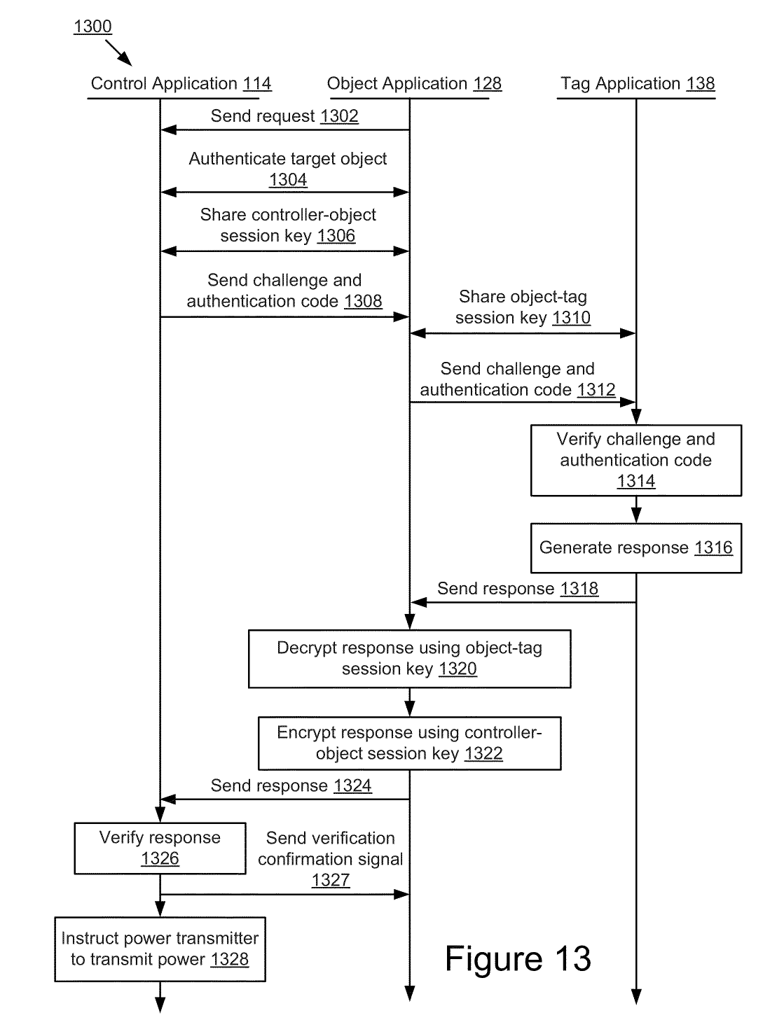

FIG. 13 is an event diagram illustrating an example process 1300 for implementing a fifth secure wireless charging protocol. In one embodiment, the control application 114 shares a controller-tag secret key with the tag application 138 and a controller-object secret key with the object application 128. The object application 128 sends 1302 a charging request to the control application 114. The control application 114 cooperates with the object application 128 to authenticate 1304 the target object 102. The control application 114 shares 1306 a controller-object session key with the object application 128. The control application 114 generates a challenge and an authentication code associated with the challenge. The control application 114 sends 1308 the challenge and the authentication code to the object application 128.

The object application 128 shares 1310 an object-tag session key with the tag application 138. The object application 128 sends 1312 the challenge and the authentication code to the tag application 138. The tag application 138 verifies 1314 the challenge and the authentication code. Responsive to a successful verification of the challenge and the authentication code, the tag application 138 generates 1316 a first encrypted response:

R_{encrypt-tag}=g(R=f(C,S_{controller-tag}),K_{object-tag-session}).

The tag application 138 sends 1318 the first encrypted response to the object application 128. The object application 128 decrypts 1320 the first encrypted response using the object-tag session key. The object application 128 encrypts 1322 the response to generate a second encrypted response:

R_{encrypt}=g(R=f(C,S_{controller-tag}),K_{controller-object-session}).

The object application 128 sends 1324 the second encrypted response to the control application 114. The control application 114 verifies 1326 the second encrypted response. The control application 114 sends 1327 a verification confirmation signal to the object application 128 responsive to a successful verification of the second encrypted response. The control application 114 instructs 1328 the power transmitter 118 to transmit power to the power receiver 106.

FIG. 14 is an event diagram illustrating an example process 1400 for implementing a challenge-response authentication process. The example challenge-response authentication process is applied to authenticate Entity B to Entity A. Entity A and Entity B can be any entities. For example, Entity A can be one of the charging controller 112 and the charging server 142, and Entity B can be one of the target object 102 and the tagging device 120. In one embodiment, Entity A and Entity B share a secret key. Entity B sends 1402 a request to Entity A. Entity A generates 1404 a challenge and sends 1406 the challenge to Entity B. Entity B generates 1408 a response using the challenge and the shared secret key. For example, Entity B generates a response “R=f (C, S_{A-B}),” where the symbol “C” represents the challenge and the symbol “S_{A-B}” represents the shared secret key. Entity B sends 1410 the response to Entity A. Entity A verifies 1412 the response. Entity A sends 1414 a confirmation signal to Entity B responsive to a successful verification of the response.

### Graphic Representations

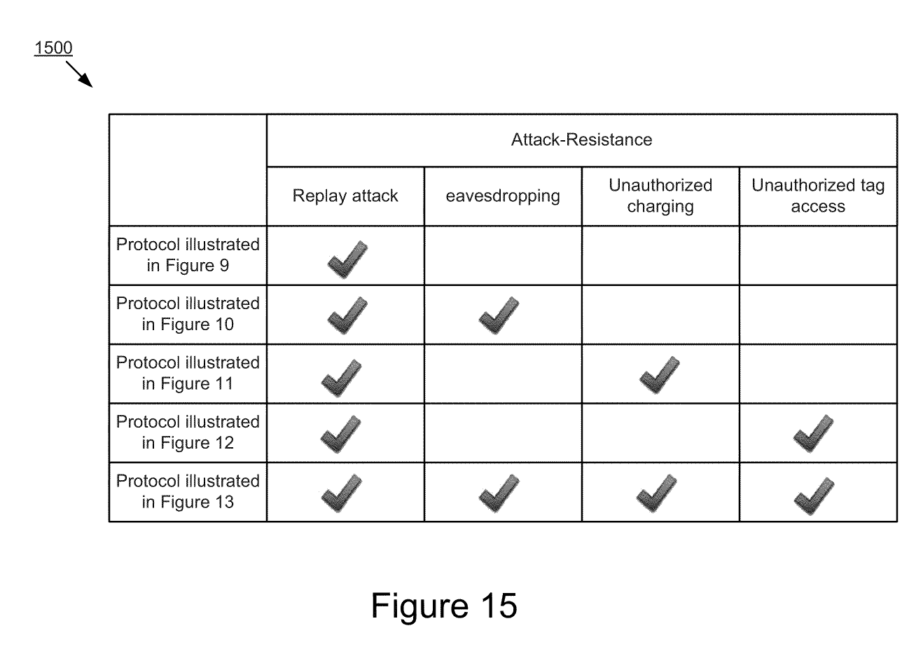

FIG. 15 is a graphic representation 1500 illustrating various security features associated with various secure wireless charging protocols according to one embodiment. The example secure wireless charging protocol illustrated in FIG. 9 applies a challenge implementation, and is resistant to replay attack. The example secure wireless charging protocol illustrated in FIG. 10 applies a challenge implementation and a data encryption implementation, and is resistant to replay attack and eavesdropping. The example secure wireless charging protocol illustrated in FIG. 11 applies a challenge implementation and an authentication process to authenticate the target object 102, and is resistant to replay attack and unauthorized charging.

The example secure wireless charging protocol illustrated in FIG. 12 applies (1) a challenge implementation and (2) an authentication process to verify the challenge and an associated authentication code at the tagging device 120, and is resistant to replay attack and unauthorized tag access. The example secure wireless charging protocol illustrated in FIG. 13 applies (1) a challenge implementation, (2) a data encryption implementation, (3) an authentication process to authenticate the target object 102 and (4) an authentication process to verify the challenge and an associated authentication code at the tagging device 120. The example secure wireless charging protocol illustrated in FIG. 13 is resistant to replay attack, eavesdropping, unauthorized charging and unauthorized tag access.

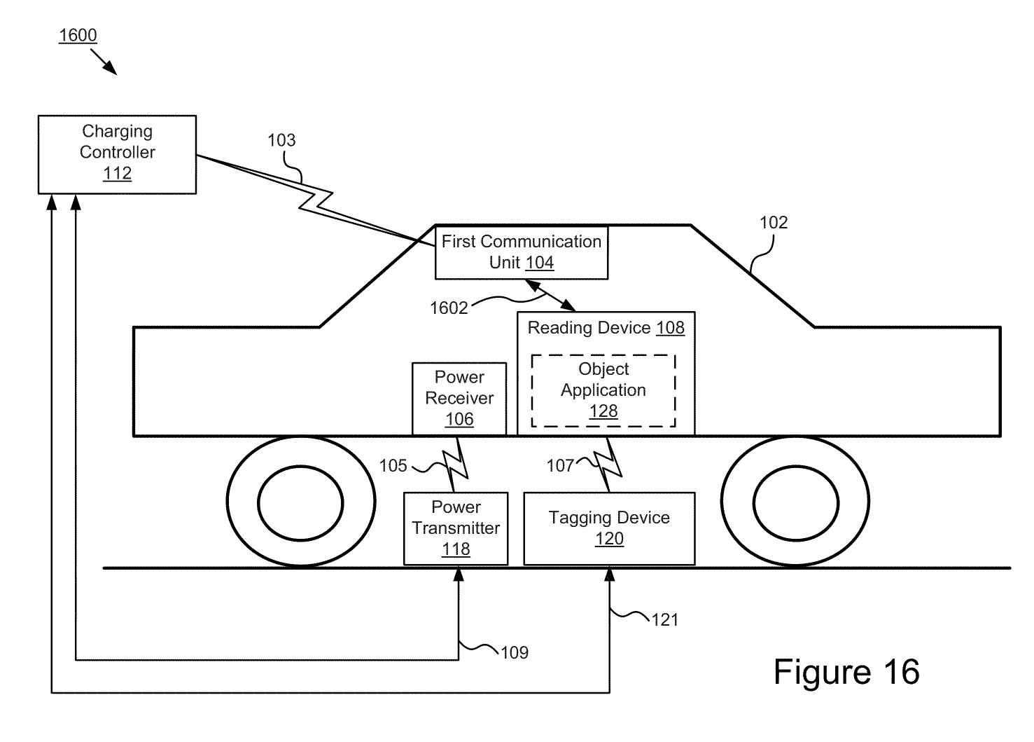

FIG. 16 is a graphic representation 1600 illustrating an example wireless charging system. In the illustrated embodiment, the target object 102 is a vehicle. The power transmitter 118 is positioned right below the power receiver 106 and the tagging device 120 is positioned right below the reading device 108. The reading device 108 is placed close by the power receiver 106 and the tagging device 120 is placed close by the power transmitter 118. For example, the reading device 108 is attached to the power receiver 106 and the tagging device 120 is attached to the power transmitter 118. If the reading device 108 is capable of reading the response from the tagging device 120 successfully, the charging distance between the power transmitter 118 and the power receiver 106 satisfies the safe charging distance (e.g., the charging distance≦the safe charging distance), which indicates that the power receiver 106 is in close proximity to the power transmitter 118 (e.g., the power receiver 106 being right above the power transmitter 118 as illustrated in FIG. 16). The power transmitter 118 can transmit power safely to the power receiver 106 using a wireless connection.

In the illustrated embodiment, the reading device 108 is communicatively coupled to the first communication unit 104 via signal line 1602. The reading device 108 sends the response obtained from the tagging device 120 to the control application 114 via the first communication unit 104, causing the control application 114 to verify the response. The control application 114 instructs the power transmitter 118 to transmit power to the power receiver 106 using a wireless connection responsive to a successful verification of the response.

FIG. 17 is a graphic representation 1700 illustrating an example safe charging range 1704 and an example safe charging distance 1702. The graphic representation 1700 depicts a power transmitter 118, a power receiver 106 and a charging distance 1706 between the power transmitter 118 and the power receiver 106. The graphic representation 1700 also depicts a tagging device 120 attached to the power transmitter 118, a reading device 108 attached to the power receiver 106 and a reading distance 1708 between the reading device 108 and the tagging device 120. The charging distance 1706 satisfies the safe charging distance 1702. For example, the charging distance 1706 is less than the safe charging distance 1702. The location of the target object 102 is located within the safe charging range 1704, so that the power transmitter 118 can transmit power wirelessly to the power receiver 106.

In the above description, for purposes of explanation, numerous specific details are set forth in order to provide a thorough understanding of the specification. It will be apparent, however, to one skilled in the art that the disclosure can be practiced without these specific details. In other implementations, structures and devices are shown in block diagram form in order to avoid obscuring the description. For example, the present implementation is described in one implementation below primarily with reference to user interfaces and particular hardware. However, the present implementation applies to any type of computing device that can receive data and commands, and any peripheral devices providing services.

Reference in the specification to “one implementation” or “an implementation” means that a particular feature, structure, or characteristic described in connection with the implementation is included in at least one implementation of the description. The appearances of the phrase “in one implementation” in various places in the specification are not necessarily all referring to the same implementation.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present implementation of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementation, an entirely software implementation or an implementation containing both hardware and software elements. In a preferred implementation, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
receiving data describing a charging request from a target object;
generating a challenge responsive to the charging request;
sending the challenge to the target object;
receiving a response from the target object;
verifying the response to determine that the response matches the challenge and a first set of secret data shared with a tagging device;
determining that a location associated with the target object satisfies a safe charging range responsive to the verification of the response; and
instructing a power transmitter associated with the target object to transmit power wirelessly to a power receiver associated with the target object responsive to the verification of the response and the determination that the location satisfies the safe charging range.

2. The method of claim 1, wherein the response includes a transformation of the challenge and the first set of secret data using a response function.

3. The method of claim 1, further comprising:
sharing a session key with the target object; and
wherein the response received from the target object is encrypted using the session key.

4. The method of claim 1, wherein the challenge is a random number uniquely associated with the charging request.

5. The method of claim 1, further comprising:
receiving object authentication data from the target object; and
authenticating the target object based on the object authentication data and a second set of secret data shared with the target object.

6. The method of claim 5, wherein authenticating the target object comprises:
performing, based on the second set of secret data, a challenge-response authentication process to authenticate the target object.

7. The method of claim 1, further comprising:
generating an authentication code associated with the challenge; and
sending the authentication code to the tagging device via the target object.

8. A computer program product comprising a computer usable medium including a computer readable program, wherein the computer readable program when executed on a computer causes the computer to:
receive data describing a charging request from a target object;
generate a challenge responsive to the charging request;
send the challenge to the target object;
receive a response from the target object;
verify the response to determine that the response matches the challenge and a first set of secret data shared with a tagging device;
determine that a location associated with the target object satisfies a safe charging range responsive to the verification of the response; and
instruct a power transmitter associated with the target object to transmit power wirelessly to a power receiver associated with the target object responsive to the verification of the response and the determination that the location satisfies the safe charging range.

9. The computer program product of claim 8, wherein the response includes a transformation of the challenge and the first set of secret data using a response function.

10. The computer program product of claim 8, wherein the computer readable program when executed by the computer causes the computer to also:
share a session key with the target object; and
wherein the response received from the target object is encrypted using the session key.

11. The computer program product of claim 8, wherein the challenge is a random number uniquely associated with the charging request.

12. The computer program product of claim 8, wherein the computer readable program when executed by the computer causes the computer to also:
receive object authentication data from the target object; and
authenticate the target object based on the object authentication data and a second set of secret data shared with the target object.

13. The computer program product of claim 12, wherein authenticating the target object comprises:
performing, based on the second set of secret data, a challenge-response authentication process to authenticate the target object.

14. The computer program product of claim 8, wherein the computer readable program when executed by the computer causes the computer to also:
generate an authentication code associated with the challenge; and
send the authentication code to the tagging device via the target object.

15. A system comprising:
a processor; and
a memory storing instructions that, when executed, cause the system to:
receive data describing a charging request from a target object;
generate a challenge responsive to the charging request;
send the challenge to the target object;
receive a response from the target object;
verify the response to determine that the response matches the challenge and a first set of secret data shared with a tagging device;
determine that a location associated with the target object satisfies a safe charging range responsive to the verification of the response; and
instruct a power transmitter associated with the target object to transmit power wirelessly to a power receiver associated with the target object responsive to the verification of the response and the determination that the location satisfies the safe charging range.

16. The system of claim 15, wherein the response includes a transformation of the challenge and the first set of secret data using a response function.

17. The system of claim 15, wherein the instructions when executed cause the system to also:
share a session key with the target object; and
wherein the response received from the target object is encrypted using the session key.

18. The system of claim 15, wherein the challenge is a random number uniquely associated with the charging request.

19. The system of claim 15, wherein the instructions when executed cause the system to also:
receive object authentication data from the target object; and
authenticate the target object based on the object authentication data and a second set of secret data shared with the target object.

20. The system of claim 19, wherein the instructions when executed cause the system to authenticate the target object by:
performing, based on the second set of secret data, a challenge-response authentication process to authenticate the target object.
